(19) United States
(12) Patent Application Publication
(10) Pub. No.: US 2010/0075079 A1
(43) Pub. Date: Mar. 25, 2010

(54) OZONE RESISTANT COMPOSITIONS AND ARTICLES

(75) Inventors: Teresa E. Bernal-Lara, Houston, TX (US); Tanya A. Fry, Lake Jackson, TX (US); Maria Isabel Arroyo Villan, Tarragona (ES)

Correspondence Address: The Dow Chemical Company, Intellectual Property Section, P.O. Box 1967, Midland, MI, 48641-1967, US

(73) Assignee: Dow Global Technologies Inc., Midland, MI (US)

(21) Appl. No.: 12/521,139

(22) PCT Filed: Dec. 19, 2007
(86) PCT No.: PCT/US07/88072

§ 371 Date: Jun. 25, 2009

Related U.S. Application Data
(60) Provisional application No. 60/877,892, filed on Dec. 29, 2006.

(51) Int. Cl. B32B 1/02; C08K 5/20; C08K 5/5419; C08K 5/01; C08K 5/02; C08F 210/02; C08F 210/06; B32B 9/04; B32B 27/08; B32B 15/08; B32B 27/34; B32B 27/36; B32B 27/30; B32B 27/32

(52) U.S. Cl. 428/35.2; 524/210; 524/269; 524/81; 526/348; 428/447; 428/484.1; 428/516; 428/461; 428/476.9; 428/483; 428/518; 428/476.1

(57) ABSTRACT

The invention relates to a composition comprising a propylene-based interpolymer and a saturated compound selected from the group consisting of aliphatic amides, hydrocarbon waxes, hydrocarbon oils, fluorinated hydrocarbons, and siloxanes, and wherein the propylene-based interpolymer comprises (a) greater than 50 mole percent propylene, based on the total moles of polymerizable monomers, and (b) ethylene, or ethylene and more unsaturated comonomers, or one or more unsaturated comonomers, and wherein the propylene-based interpolymer has at least one of the following properties: (i) 13C NMR peaks corresponding to a regio-error at about 14.6 and about 15.7 ppm, the peaks of about equal intensity, and (ii) a DSC curve with a Tme that remains essentially the same, and a TMax that decreases as the amount of comonomer in the interpolymer is increased. The invention also provides for articles, such as films, comprising at least one component formed from an inventive composition, and for methods of making the same.

### REFERENCE TO RELATED APPLICATIONS

The present application claims the benefit of U.S. Provisional Application No. 60/877,892, filed on Dec. 29, 2006, and fully incorporated herein by reference.

### BACKGROUND OF INVENTION

Drinking water is typically packaged in containers prepared from one or more polymeric compositions. In the packaging industry, ozone (O₃) is commonly used for sterilization of drinking water. During the bottling process, ozone is applied as the last step to disinfect and kill any air-borne microorganisms that may be present at the time of filling. Due to its strong oxidizing character, ozone can effectively kill microorganisms, however, ozone can also cause undesirable reactions with the plastic package. The products and byproducts of these reactions are responsible for the off-taste odor that characterizes ozonated water, especially if packaged in flexible polyolefin containers.

The effects of ozone on polyethylene-based polymers and other polymers have been published. For example, see the following: (a) Migration of Volatile Degradation Products into Ozonated Water from Plastic Packaging Materials; Song, Y. S.; Al-Taher, F.; Sadler, G. Food Additives & Contaminants, (2003), 20(10), 985-994 (identifies volatile compounds and their concentration in water after ozonation of several types of plastic materials, and compares the concentration found, with that approved by the FDA); (b) The influence of Different Sterilization Methods on Chemical and Physical Properties of Food Packaging Made of Plastics; Steiner, I.; Grundschober, J.; Dobias, J.; Sipek, M.; Washuttl, J.; Voldrich, M.; Lebensmittelchemie, (1999), 53(3), 59, Abstract (discusses the effects of sterilization (ozone, H₂O₂, ClO₂ and γ-irradn) on polyethylene bottles, foils and PET); (c) Changes in a Polyethylene Food Packaging Film Following Ozone Sterilization; Steiner, Ingrid; Deutsche Lebensmittel-Rundschau, (1991), 87(4), 107-12, Abstract (discusses the effects of ozone sterilization on polyethylene film and on the antioxidant butylhydroxyanisole); (d) Ozonation Effect on Taste in Water Packaged in High Density Polyethylene Bottles; White, C. H.; Gough, R. H.; McGregor, J. U.; Vickroy, V. V.; Journal of Dairy Science, (1991), 74(1), 96-9, Abstract (discusses the off-taste produced by the ozonation of water, bottled in containers formed from high density polyethylene, and also discusses a treatment using butylated hydroxytoluene); (e) Surface Ozonation and Photooxidation of Polyethylene Film; Peeling, James; Clark, David T; Journal of Polymer Science, Polymer Chemistry Edition (1983), 21(7), 2047-55 (describes the surface effects of ozone and photo-oxidation on film formed from high density polyethylene and low density polyethylene); and (f) Ozone and Its Current and Future Application in the Food Industry; Kim Jin-Gab; Yousef Ahmed E; Khadre Mohammed A; Advances in Food and Nutrition Research (2003), 45 167-218, Abstract (reviews the use of ozone as a sanitizer in the food industry).

Zeolites, silicates and flavor protectants have been used in an attempt to eliminate odors from sterilized water. U.S. Publication No. 2002/0020672 discloses an in-situ method of treating ozone sterilized water to remove unwanted odors and tastes produced during the sterilization process. Odors are removed by the incorporation of a zeolite into the cap or cap liner of a container.

However, the use of one or more additives to improve taste and odor, such as a zeolite, a silicate or a flavor protectant, will increase the cost of a resin formulation.

International Publication No. WO 92/13029 discloses a process for eliminating odor producing and taste producing substances in plastic materials, by adding a substantially hydrophobic aluminum silicate molecular sieve to the plastic material. The plastic material is preferably an ethylene plastic or a propylene plastic.

European Patent EP 0687706B1 (Abstract) discloses a polyolefin-based composition comprising a lubricating agent chosen from glycerol esters, amides of saturated or unsaturated fatty acids or mixtures thereof, and a zeolite (crystalline aluminosilicate). The polyolefin composition can be used for molded articles, such as plastic bottles.

International Publication No. WO 96/04833 discloses a liner composition for a portable fluid container. The composition contains an inactivated hydrazine, and/or an inorganic sulfite and/or a tocopherol compound for preventing off-flavors due to the presence of aldehydes in the fluid.

German application DE 100 60 478 A1 (Abstract) discloses a method for obtaining water free from bacteria and smells, comprising treating of water with ozone in a container filled with active carbon and/or substances containing zeolite.

International Publication No. WO 00/68106 discloses a bottled liquid, such as bottled water, where the liquid has little or no plastic off-taste. The bottle contains a closure liner which comprises a plastic matrix and an organic slip agent dispersed in the plastic matrix. The slip agent is substantially fully ethylenically saturated and the liner is substantially free of an ethylenically unsaturated compound. Suitable ethylenically saturated slip agents include behenamide, polysiloxane, fluoropolymers, paraffin wax, carbowax, synthetic mineral oil and mixtures thereof.

U.S. Publication No. 2004/0222165 discloses methods of packaging ozone sterilized products in plastic film containers, wherein adverse organoleptic reactions or interactions are substantially reduced. Ozone sterilized water is packaged in flexible plastic pouches having an inner polyethylene liner formed from polyethylene, which does not contain slip agents or other organic processing aids which may react with ozone.

Propylene-based films have been used in the packaging industry; however typically they have not been used for packaging of ozone treated water.

International Publication No. WO 2005/103123 discloses a propylene-based composition suitable for use in a single-sided stretch film, and comprising from 0.1 to 20 weight percent of a propylene-based copolymer and from 80 to 99 weight percent of an ethylene-based copolymer.

International Publication No. WO 03/040202 (see also U.S. Pat. No. 6,919,407 and U.S. Pat. No. 6,960,635) discloses films with excellent machine direction tear properties, and comprising at least one layer formed from a polymer comprising at least 50 weight percent propylene and at least 5 weight percent ethylene and/or one or more unsaturated comonomers.

U.S. Publication No. 2002/0006482 discloses a multilayered blown film containing a polypropylene layer and a polyethylene sealant layer. The multilayered film exhibits excellent interlayer adhesion and toughness, with acceptable optical properties and sealing properties. The film is suitable for making pouches, heavy duty shipping sacks and overwrap films.

However, there is a need for polyolefin compositions for use in packaging of ozone treated liquids, and especially ozone treated water, that lead to a reduction in the off-taste and odor of the liquid. There a further need for polyolefin compositions that does not require the use of additives, in addition to the standard processing additives, for taste and odor reduction. Also, there is a need in the packaging industry for polyolefins with improved heat seal and hot tack properties that can improve package integrity and/or increase packaging speed, with minimal formation of by-products that cause off-taste and odor. Some of these needs and others have been met by the following invention.

### SUMMARY OF THE INVENTION

The invention provides a composition comprising a propylene-based interpolymer and a saturated compound selected from the group consisting of aliphatic amides, hydrocarbon waxes, hydrocarbon oils, fluorinated hydrocarbons and siloxanes, and

wherein the propylene-based interpolymer comprises (a) greater than 50 mole percent propylene, based on the total moles of polymerizable monomers, and (b) ethylene, or ethylene and one or more unsaturated comonomers, or one or more unsaturated comonomers, and

wherein the propylene-based interpolymer has at least one of the following properties:
(i) 13C NMR peaks corresponding to a regio-error at about 14.6 and about 15.7 ppm, the peaks of about equal intensity, and
(ii) a DSC curve with a Tₘₑ that remains essentially the same, and a Tₘₐₓ that decreases as the amount of comonomer (i.e., units derived from ethylene and/or the unsaturated comonomer(s)) in the interpolymer is increased.

The invention also provides a method of preparing a composition comprising a propylene-based interpolymer and a saturated compound selected from the group consisting of aliphatic amides, hydrocarbon waxes, hydrocarbon oils, fluorinated hydrocarbons and siloxanes, said method comprising mixing the saturated compound with the propylene-based interpolymer, and

wherein the propylene-based interpolymer comprises (a) greater than 50 mole percent propylene, based on the total moles of polymerizable monomers, and (b) ethylene, or ethylene and one or more unsaturated comonomers, or one or more unsaturated comonomers, and

wherein the propylene-based interpolymer has at least one of the following properties:
(i) 13C NMR peaks corresponding to a regio-error at about 14.6 and about 15.7 ppm, the peaks of about equal intensity, and
(ii) a DSC curve with a Tₘₑ that remains essentially the same and a Tₘₐₓ that decreases as the amount of comonomer (i.e., units derived from ethylene and/or the unsaturated comonomer(s)) in the interpolymer is increased.

The invention also provides for articles prepared from the inventive compositions.

The invention also provides a pouch comprising a film layer formed from a composition comprising a propylene-based interpolymer, and

wherein the propylene-based interpolymer comprises (a) greater than 50 mole percent propylene, based on the total moles of polymerizable monomers, and (b) ethylene, or ethylene and one or more unsaturated comonomers, or one or more unsaturated comonomers, and

wherein the propylene-based interpolymer has at least one of the following properties:
(i) 13C NMR peaks corresponding to a regio-error at about 14.6 and about 15.7 ppm, the peaks of about equal intensity, and
(ii) a DSC curve with a Tₘₑ that remains essentially the same, and a Tₘₐₓ that decreases as the amount of comonomer in the interpolymer is increased.

### BRIEF DESCRIPTION OF THE DRAWINGS

FIG. 1 depicts the hedonic rating for non-ozonated water and ozonated water samples, each exposed to films formed from an inventive propylene-based composition and to films formed from other ethylene-based polymers.

FIG. 2 depicts the relative amounts of aldehydes and a ketone in non-ozonated and ozonated water samples, each exposed to films formed from an inventive propylene-based composition and to films formed from other ethylene-based polymers.

FIG. 3 depicts the correlation between the relative amounts of aldehydes and ketones versus hedonic rating for ozonated water exposed to films formed from an inventive propylene-based composition and to films formed from other ethylene-based polymers.

FIG. 4 depicts the hedonic rating for ozone treated water exposed to films formed from an inventive propylene-based composition and to films formed from other ethylene and polypropylene based polymers.

FIG. 5 depicts a comparison of the ozonated water exposed to films formed from an inventive propylene-based composition containing various additives.

FIG. 6 depicts the kinetic COF (Coefficient of Friction) of films formed from propylene-based compositions containing various additives versus hedonic rating of ozonated water exposed to such films.

FIG. 7 depicts a thermal desorption GC/MS profile for an ethylene-based polymer.

FIG. 8 depicts seal strength versus temperature profiles of a sealant prepared from an inventive composition and sealants prepared from ethylene-based polymers.

FIG. 9 depicts seal strength versus temperature profiles of sealants prepared from inventive compositions and a sealant prepared from another propylene-based polymer.

FIG. 10 depicts hot tack strength versus temperature profile of a multilayer film with a sealant layer prepared from the inventive composition and a multilayer film with a sealant layer prepared from a linear low density polyethylene and low density polyethylene blend.

### DETAILED DESCRIPTION OF THE INVENTION

The invention provides compositions that can be used to form films with minimal contribution to taste/odor of ozone sterilized water, when compared to films made of typical polyethylene sealants, such as, ethylene-octene, ethylene-butene, linear low density polyethylene and low density polyethylene. The inventive compositions form films with excellent sealant and organoleptic properties for flexible packaging of ozone sterilized water.

In particular, the invention provides a composition comprising a propylene-based interpolymer and a saturated compound selected from aliphatic amides, hydrocarbon waxes, hydrocarbon oils, fluorinated hydrocarbons or siloxanes, and

wherein the propylene-based interpolymer comprises (a) greater than 50 mole percent propylene, based on the total moles of polymerizable monomers, and (b) ethylene, or ethylene and one or more unsaturated comonomers, or one or more unsaturated comonomers, and

wherein the propylene-based interpolymer has at least one of the following properties:
(i) 13C NMR peaks corresponding to a regio-error at about 14.6 and about 15.7 ppm, the peaks of about equal intensity, and
(ii) a DSC curve with a Tₘₑ that remains essentially the same, and a Tₘₐₓ that decreases as the amount of comonomer (i.e., units derived from ethylene and/or the unsaturated comonomer(s)) in the interpolymer is increased.

In one embodiment, the propylene-based interpolymer comprises (a) greater than 50 mole percent propylene, based on the total moles of polymerizable monomers, and (b) ethylene.

In regard to the 13C NMR parameters, a region-error at about 14.6 includes ppm values within a plus/minus 10 percent of 14.6 (or 13.1 ppm to 16.1 ppm). A region-error at about 15.7 ppm includes ppm values within a plus/minus 10 percent of 15.7 (or 14.1 ppm to 17.3 ppm). The phrase “peaks of about equal intensity” refers to a peak difference less than 20 percent of the larger peak, and preferably less than 10 percent of the larger peak.

In regard to DSC parameters, the phrase “Tme remains essentially the same,” refers to a Tme that is within plus/minus 5° C., preferably within plus/minus 3° C. of other Tme values.

In another embodiment, the propylene-based interpolymer comprises (a) greater than 50 mole percent propylene, based on the total moles of polymerizable monomers, and (b) ethylene.

In another embodiment, the propylene-based interpolymer comprises (a) greater than 50 mole percent propylene, based on the total moles of polymerizable monomers, and (b) ethylene and one or more unsaturated comonomers.

In another embodiment, the propylene-based interpolymer comprises (a) greater than 50 mole percent propylene, based on the total moles of polymerizable monomers, and (b) one or more unsaturated comonomers.

In one embodiment, the propylene-based interpolymer comprises greater than 55 mole percent propylene, based on the total moles of polymerizable monomers.

In one embodiment, the propylene-based interpolymer comprises greater than 60 mole percent propylene, based on the total moles of polymerizable monomers.

In another embodiment, the propylene-based interpolymer comprises greater than 70 mole percent propylene, based on the total moles of polymerizable monomers.

In another embodiment, the propylene-based interpolymer comprises greater than 80 mole percent propylene, based on the total moles of polymerizable monomers.

In another embodiment, the propylene-based interpolymer comprises greater than 90 mole percent propylene, based on the total moles of polymerizable monomers.

In one embodiment, the propylene-based interpolymer has the following property:
(i) 13C NMR peaks corresponding to a regio-error at about 14.6 and about 15.7 ppm, the peaks of about equal intensity.

In another embodiment, the propylene-based interpolymer has the following property:
(ii) a DSC curve with a Tₘₑ that remains essentially the same, and a Tₘₐₓ that decreases as the amount of comonomer in the interpolymer is increased.

In another embodiment, the propylene-based interpolymer further has at least one of the following properties:
(iii) a skewness index, Sᵢₓ, greater than about −1.20, and
(iv) an X-ray diffraction pattern that reports more gamma-form crystals than a comparable interpolymer prepared with a Ziegler-Natta catalyst.

In another embodiment, the saturated compound contains a structural unit represented by Formula (I):

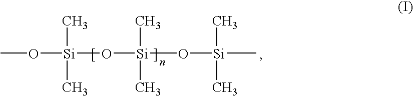

where n is greater than 10.

In another embodiment, the saturated compound is represented by Formula (II):

CH₃—(CH₂)ₙ—CONH₂ (II),

wherein n is greater than, or equal to, 6.

In another embodiment, saturated compound is a hydrocarbon wax. In a further embodiment, the hydrocarbon waxes is selected from paraffin wax, carbowax, or beeswax. In another embodiment, the hydrocarbon waxes is selected from waxes of general formula, CH₃—(CH₂)ₙ—CH₃, where n is greater than 20.

In another embodiment, the saturated compound is a hydrocarbon oil. In a further embodiment, the hydrocarbon oil is selected from mineral oils, vegetable oils, petroleum oils, or animal oils. In another embodiment, the hydrocarbon oil is selected from oils of general formula, CH₃—(CH₂)ₙ—CH₃, where n is less than 20.

In another embodiment, the saturated compound is a fluorinated hydrocarbon. In a further embodiment, the fluorinated hydrocarbon is selected from tetra fluoroethylene polymers, polyvinylidene fluoride or hexafluoropropylene.

In a further embodiment, the propylene-based interpolymer has at least one of the following properties:
(i) 13C NMR peaks corresponding to a regio-error at about 14.6 and about 15.7 ppm, the peaks of about equal intensity,
(ii) a DSC curve with a Tₘₑ that remains essentially the same and a Tₘₐₓ that decreases as the amount of comonomer (i.e., units derived from ethylene and/or the unsaturated comonomer(s)) in the interpolymer is increased, and
(iii) a skewness index, Sᵢₓ, greater than about −1.20.

In another embodiment, the propylene-based interpolymer has at least one of the following properties:
(i) 13C NMR peaks corresponding to a regio-error at about 14.6 and about 15.7 ppm, the peaks of about equal intensity, and
(iii) a skewness index, Sᵢₓ, greater than about −1.20.

In another embodiment, the propylene-based interpolymer has a
(i) 13C NMR peaks corresponding to a regio-error at about 14.6 and about 15.7 ppm, the peaks of about equal intensity, and
(ii) a DSC curve with a Tₘₑ that remains essentially the same and a Tₘₐₓ that decreases as the amount of comonomer (i.e., units derived from ethylene and/or the unsaturated comonomer(s)) in the interpolymer is increased.

In another embodiment, the propylene-based interpolymer has the following properties:
(i) 13C NMR peaks corresponding to a regio-error at about 14.6 and about 15.7 ppm, the peaks of about equal intensity, and
(iv) an X-ray diffraction pattern that reports more gamma-form crystals than a comparable interpolymer prepared with a Ziegler-Natta catalyst.

In one embodiment, the propylene-based interpolymer is a propylene/ethylene interpolymer. In a further embodiment, the propylene/ethylene interpolymer comprises from 2 to 30 weight percent, preferably 2 to 20 weight percent, and more preferably 5 to 15 weight percent, and even more preferably 9 to 12 weight percent ethylene, based on the total amount of polymerizable monomers.

In one embodiment, the propylene-based interpolymer has a melt flow rate (MFR) from 0.1 to 100 g/10 min, preferably from 0.5 to 50 g/10 min, and more preferably from 1 to 10 g/10 min.

In one embodiment, the propylene-based interpolymer has a density from 0.84 to 0.90 g/cc, and preferably from 0.86 to 0.88 g/cc.

In one embodiment, the composition does not comprise a zeolite.

The inventive compositions may comprise a combination of two or more embodiments as described herein.

The invention also provides a film comprising at least one layer formed from an inventive composition.

In another embodiment, the film comprises at least three layers, and wherein at least one outer layer is formed from an inventive composition. In a further embodiment, an inner layer is formed from a composition comprising a HDPE, polypropylene homopolymer, or a propylene-based interpolymer.

In another embodiment, the film comprising at least two layers, and wherein at least one layer is formed from an inventive composition. In a further embodiment, another layer is formed from a composition comprising a HDPE, polypropylene homopolymer, or a propylene-based interpolymer.

In one embodiment, the film has a seal strength of at least 1 lbf/inch at a sealing temperature in the range from 100° C. or less, preferably 90° C. or less.

In one embodiment, the film has an ultimate seal strength greater than 3 lbf/in, preferably greater than 4 lbf/in.

In one embodiment, the film has a hot tack strength of at least 4 N/in at a sealing temperature in the range from 110° C. or less, preferably 100° C. or less, and more preferably 90° C.

In one embodiment, the film has an ultimate hot tack strength greater than 5 N/in, preferably greater than 6 N/in.

The inventive films may comprise a combination of two or more embodiments as described herein.

The invention also provides a laminate structure comprising a film formed from an inventive composition and a substrate, and wherein the film is laminated to the substrate. In a further embodiment, the substrate is formed from a composition comprising at least one selected from foil, polyamide, polyester, ethylene/vinyl alcohol (EVOH) copolymers, polyvinylidene chloride (PVDC), polyethylene terepthalate (PET), oriented polypropylene (OPP), ethylene/vinyl acetate (EVA) copolymers, ethylene/acrylic acid (EM) copolymers, ethylene/methacrylic acid (EMAA) copolymers, SiOx coated films, PVDC coated films, ULDPE, LLDPE, HDPE, MDPE, LMDPE, LDPE, ionomers, graft-modified polymers (e.g., maleic anhydride grafted polyethylene), or paper. In another embodiment, the substrate is formed from a composition comprising at least one selected from foil, nylon, ethylene/vinyl alcohol (EVOH) copolymers, polyvinylidene chloride (PVDC), polyethylene terepthalate (PET), oriented polypropylene (OPP), SiOx coated films, or PVDC coated films.

The inventive laminate structures may comprise a combination of two or more embodiments as described herein.

The invention also provides an article comprising at least one component formed from an inventive composition. In a further embodiment, the article is a film pouch. In yet a further embodiment, the film pouch comprises at least two layers.

The invention also provides an article comprising at least one component formed from an inventive film as described herein. In a further embodiment, the article is a film pouch, and wherein the interior layer of the pouch is formed from an inventive composition.

The invention also provides a film pouch comprising at least one component formed from an inventive composition.

In one embodiment, the pouch comprises at least two layers or plies.

In one embodiment, an interior layer of the pouch is formed from an inventive composition.

In one embodiment, an outer layer of the pouch is formed from a composition comprising a HDPE, a polypropylene homopolymer, or a propylene-based interpolymer.

The invention also provides a pouch comprising a film layer formed from a composition comprising a propylene-based interpolymer, and

wherein the propylene-based interpolymer comprises (a) greater than 50 mole percent propylene, based on the total moles of polymerizable monomers, and (b) ethylene, or ethylene and one or more unsaturated comonomers, or one or more unsaturated comonomers, and

wherein the propylene-based interpolymer has at least one of the following properties:
(iii) 13C NMR peaks corresponding to a regio-error at about 14.6 and about 15.7 ppm, the peaks of about equal intensity, and
(iv) a DSC curve with a Tₘₑ that remains essentially the same, and a Tₘₐₓ that decreases as the amount of comonomer in the interpolymer is increased.

In one embodiment, the propylene-based interpolymer has a density from 0.86 to 0.90 g/cc.

In another embodiment, the composition comprises a saturated compound selected from the group consisting of aliphatic amides, hydrocarbon waxes, hydrocarbon oils, fluorinated hydrocarbons and siloxanes.

An inventive pouch may comprise a combination of two or more embodiments as described herein.

The invention also provides an article comprising at least one component formed from an laminate structure as described herein.

The inventive articles may comprise a combination of two or more embodiments as described herein.

The invention also provides a method of preparing a composition comprising a propylene-based interpolymer and a saturated compound selected from aliphatic amides, hydrocarbon waxes, hydrocarbon oils, fluorinated hydrocarbons or siloxanes, said method comprising mixing the saturated compound with the propylene-based interpolymer, and

wherein the propylene-based interpolymer comprises (a) greater than 50 mole percent propylene, based on the total moles of polymerizable monomers, and (b) ethylene, or ethylene and one or more unsaturated comonomers, or one or more unsaturated comonomers, and

wherein the propylene-based interpolymer has at least one of the following properties:
(i) 13C NMR peaks corresponding to a regio-error at about 14.6 and about 15.7 ppm, the peaks of about equal intensity, and
(ii) a DSC curve with a Tₘₑ that remains essentially the same, and a T_{Max} that decreases as the amount of comonomer (i.e., units derived from ethylene and/or the unsaturated comonomer(s)) in the interpolymer is increased.

In one embodiment, the propylene-based interpolymer has the following property:
(i) 13C NMR peaks corresponding to a regio-error at about 14.6 and about 15.7 ppm, the peaks of about equal intensity.

In another embodiment, the propylene-based interpolymer has the following property:
(ii) a DSC curve with a Tₘₑ that remains essentially the same, and a Tₘₐₓ that decreases as the amount of comonomer in the interpolymer is increased.

In another embodiment, the propylene-based interpolymer further has at least one of the following properties:
(iii) a skewness index, Sᵢₓ, greater than about −1.20, and
(iv) an X-ray diffraction pattern that reports more gamma-form crystals than a comparable interpolymer prepared with a Ziegler-Natta catalyst.

In another embodiment, the saturated compound contains a structural unit represented by Formula (I):

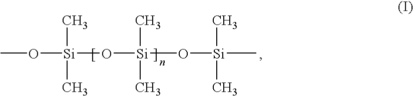

where n is greater than 10.

In another embodiment, the saturated compound is represented by Formula (II):

CH₃—(CH₂)ₙ—CONH₂ (II),

wherein n is greater than, or equal to, 6.

In another embodiment, saturated compound is a hydrocarbon wax. In a further embodiment, the hydrocarbon waxes is selected from paraffin wax, carbowax, or beeswax. In another embodiment, the hydrocarbon waxes is selected from waxes of general formula, CH₃—(CH₂)ₙ—CH₃, where n is greater than 20.

In another embodiment, the saturated compound is a hydrocarbon oil. In a further embodiment, the hydrocarbon oil is selected from mineral oils, vegetable oils, petroleum oils, or animal oils. In another embodiment, the hydrocarbon oil is selected from oils of general formula, CH₃—(CH₂)ₙ—CH₃, where n is less than 20.

In another embodiment, the saturated compound is a fluorinated hydrocarbon. In a further embodiment, the fluorinated hydrocarbon is selected from tetra fluoroethylene polymers, polyvinylidene fluoride or hexafluoropropylene.

The inventive methods may comprise a combination of two or more embodiments as described herein.

Films formed from the compositions of the invention offer little or no contribution to ozonated water taste, and without the addition of molecular sieves or zeolites, which can increase the cost of the formulation. In addition films formed from the inventive compositions have excellent sealing properties.

Even when free of any additives or ethylenically unsaturated compounds, the inventive films exhibit the least contribution to taste/odor of ozone sterilized water, when compared to films made of typical polyethylene sealants, such as ethylene-octene, ethylene-butene, linear low density polyethylene and low density polyethylene.

### Propylene-Based Polymer

The propylene-based polymers suitable in the inventive compositions comprise propylene, and typically, ethylene and/or one or more unsaturated comonomers, are characterized as having at least one, preferably more than one, of the following properties: (i) 13C NMR peaks corresponding to a regio-error at about 14.6 and about 15.7 ppm, the peaks of about equal intensity, (ii) a skewness index, Sᵢₓ, greater than about −1.20, (iii) a DSC curve with a Tₘₑ that remains essentially the same, and a T_{Max} that decreases as the amount of comonomer (i.e., units derived from ethylene and/or the unsaturated comonomer(s)) in the interpolymer is increased, and (iv) an X-ray diffraction pattern that reports more gamma-form crystals than a comparable interpolymer prepared with a Ziegler-Natta catalyst. Preferably the propylene-based interpolymer is a propylene/ethylene interpolymer. Especially preferred propylene-based polymers are the VERSIFY™ polymers available from The Dow Chemical Company. It is noted that in property (i) the distance between the two 13C NMR peaks is about 1.1 ppm.

These propylene-based interpolymers are made using a nonmetallocene, metal-centered, heteroaryl ligand catalyst. These polymers can be blended with other polymers, and are useful in the manufacture of films, sheets, foams, fibers and molded articles. Typically the interpolymers of this embodiment are characterized by at least one, preferably at least two, more preferably at least three, and even more preferably all four, of these properties.

With respect to the X-ray property of subparagraph (iv) above, a “comparable” interpolymer is one having the same monomer composition within 10 weight percent, and the same M_{W} (weight average molecular weight) within 10 weight percent. For example, if an inventive propylene/ethylene/1-hexene interpolymer is 9 weight percent ethylene and 1 weight percent 1-hexene, and has a Mw of 250,000, then a comparable polymer would have from 8.1 to 9.9 weight percent ethylene, from 0.9 to 1.1 weight percent 1-hexene, and a Mw from 225,000 to 275,000, and prepared with a Ziegler-Natta catalyst.

In one embodiment, the propylene-based interpolymers of this invention comprises units derived from propylene, in an amount of at least about 60, preferably at least about 80 and more preferably at least about 85, weight percent of the interpolymer (based on total weight of polymerizable monomers. The typical amount of units derived from ethylene in propylene/ethylene copolymers is at least about 0.1, preferably at least about 1 and more preferably at least about 5 weight percent, and the maximum amount of units derived from ethylene present in these interpolymers is typically not in excess of about 35, preferably not in excess of about 30 and more preferably not in excess of about 20, weight percent of the interpolymer (based on total weight of polymerizable monomer). The amount of units derived from additional unsaturated comonomer(s), if present, is typically at least about 0.01, preferably at least about 1 and more preferably at least about 5, weight percent, and the typical maximum amount of units derived from the additional unsaturated comonomer(s) typically does not exceed about 35, preferably it does not exceed about 30 and more preferably it does not exceed about 20, weight percent of the interpolymer (based on total weight of polymerizable monomer). The combined total of units derived from ethylene and any unsaturated comonomer typically does not exceed about 40, preferably it does not exceed about 30 and more preferably it does not exceed about 20, weight percent of the interpolymer (based on the total weight of polymerizable monomers).

In a preferred embodiment, the propylene-based interpolymer is an interpolymer of propylene, ethylene and, optionally, one or more unsaturated comonomers, for example, C4-C20 α-olefins, C4-C20 dienes, vinyl aromatic compounds (example, styrene). These interpolymers are characterized as comprising at least about 60 weight percent of units derived from propylene, from 0.1 to 35 weight percent of units derived from ethylene, and from 0 to 35 weight percent of units derived from one or more unsaturated comonomers, with the proviso that the combined weight percent of units derived from ethylene and the unsaturated comonomer(s) does not exceed about 40 weight percent (based on total weight of polymerizable monomers).

In another embodiment, propylene-based interpolymer comprises propylene and one or more unsaturated comonomers. These interpolymers are characterized in having at least about 60 weight percent of the units derived from propylene, and from 0.1 to 40 weight percent of the units derived from the unsaturated comonomer(s). Weight percentages based on total weight of polymerizable monomers.

The unsaturated comonomers used in the practice of this invention include, C4-C20 α-olefins, especially C4-C12 α-olefins such as 1-butene, 1-pentene, 1-hexene, 4-methyl-1-pentene, 1-heptene, 1-octene, 1-decene, 1-dodecene and the like; C4-C20 diolefins, preferably 1,3-butadiene, 1,3-pentadiene, norbornadiene, 5-ethylidene-2-norbornene (ENB) and dicyclopentadiene; C8-40 vinyl aromatic compounds including styrene, o-, m-, and p-methylstyrene, divinylbenzene, vinylbiphenyl, vinylnapthalene; and halogen-substituted C8-40 vinyl aromatic compounds, such as chlorostyrene and fluorostyrene.

In one embodiment, the weight average molecular weight (Mw) of the propylene-based interpolymer of this invention is from 30,000 to 1,000,000. The molecular weight distribution (Mw/Mn) of the propylene-based interpolymer is typically from 2 to 6. In another embodiment, the molecular weight distribution is from 1.2 to 6, preferably from 1.5 to 4.5, and more preferably from 2 to 3.2.

In another embodiment, propylene-based interpolymers of this invention are characterized as having substantially isotactic propylene sequences. “Substantially isotactic propylene sequences,” and similar terms, mean that the sequences have an isotactic triad (mm) measured by 13C NMR of greater than about 0.85, preferably greater than about 0.90, more preferably greater than about 0.92, and most preferably greater than about 0.93. Isotactic triads are well known in the art, and are described in, for example, U.S. Pat. No. 5,504,172, and International Publication No. WO 00/01745, which refers to the isotactic sequence in terms of a triad unit in the copolymer molecular chain determined by 13C NMR spectra.

The propylene interpolymers of this invention include, but are not limited to, propylene/ethylene, propylene/ethylene/1-butene, propylene/ethylene/ENB, propylene/ethylene/1-hexene, propylene/ethylene/1-octene, propylene/1-hexene, propylene/1-pentene, propylene/1-nonene, propylene/1-decene, propylene/1-heptene, propylene/4-methyl-1-pentene and propylene/1-butene. Suitable propylene-base interpolymers include VERSIFY™ polymers (available from The Dow Chemical Company).

In one embodiment, the propylene-based interpolymer has a melt flow rate (MFR) greater than, or equal to, 0.1, preferably greater than, or equal to 0.2, more preferably greater than, or equal to 0.5 g/10 min, and even more preferably greater than, or equal to 1 g/10 min. In another embodiment, the propylene-based interpolymer has a melt flow rate (MFR) less than, or equal to, 100, preferably less than, or equal to 50, more preferably less than, or equal to 20 g/10 min, and even more preferably less than, or equal to 10 g/10 min. The MFR is measured according to ASTM D-1238 (2.16 kg, 230° C.). In a preferred embodiment, the propylene-based interpolymer is a propylene/ethylene interpolymer. In a further embodiment, the ethylene content of the interpolymer ranges from 0.1 to 30 weight percent, preferably from 0.5 to 25 weight percent, and more preferably from 1 to 20 weight percent, based on the total weight of polymerizable monomers.

In another embodiment, the propylene-based interpolymer has a melt flow rate (MFR) from 0.1 to 100 g/10 min, preferably from 0.5 to 50 g/10 min, and more preferably from 1 to 10 g/10 min, and even more preferably from 1.5 to 8 g/10 min. All individual values and subranges from 0.1 to 100 g/10 min, are included herein and disclosed herein. The MFR is measured according to ASTM D-1238 (2.16 kg, 230° C.). In a preferred embodiment, the propylene-based interpolymer is a propylene/ethylene interpolymer. In a further embodiment, the ethylene content of the interpolymer ranges from 0.1 to 30 weight percent, preferably from 0.5 to 25 weight percent, and more preferably from 1 to 20 weight percent, based on the total weight of polymerizable monomers.

In another embodiment, the propylene-based interpolymer has a density less than, or equal to, 0.90 g/cc, preferably less than, or equal to, 0.89 g/cc, and more preferably less than, or equal to, 0.88 g/cc. In another embodiment, the propylene-based interpolymer has a density greater than, or equal to, 0.83 g/cc, preferably greater than, or equal to, 0.84 g/cc, and more preferably greater than, or equal to, 0.85 g/cc. In a preferred embodiment, the propylene-based interpolymer is a propylene/ethylene interpolymer. In a further embodiment, the ethylene content of the interpolymer ranges from 0.1 to 30 weight percent, preferably from 0.5 to 25 weight percent, and more preferably from 1 to 20 weight percent, based on the total weight of polymerizable monomers.

In another embodiment, the propylene-based interpolymer has a density from 0.83 g/cc to 0.90 g/cc, and preferably from 0.84 g/cc to 0.89 g/cc, and more preferably from 0.85 g/cc to 0.88 g/cc. All individual values and subranges from 0.83 g/cc to 0.90 g/cc, are included herein and disclosed herein. In a preferred embodiment, the propylene-based interpolymer is a propylene/ethylene interpolymer. In a further embodiment, the ethylene content of the interpolymer ranges from 0.1 to 30 weight percent, preferably from 0.5 to 25 weight percent, and more preferably from 1 to 20 weight percent, based on the total weight of polymerizable monomers.

In another embodiment, the propylene-based interpolymer has a molecular weight distribution less than, or equal to, 6, and preferably less than, or equal to, 5.5, and more preferably less than, or equal to 5. In another embodiment, the molecular weight distribution is greater than, or equal to, 2, preferably greater than, or equal to, 2.5, more preferably greater than, or equal to 3. In a preferred embodiment, the propylene-based interpolymer is a propylene/ethylene interpolymer. In a further embodiment, the ethylene content of the interpolymer ranges from 0.1 to 30 weight percent, preferably from 0.5 to 25 weight percent, and more preferably from 1 to 20 weight percent, based on the total weight of polymerizable monomers.

In another embodiment, the propylene-based interpolymer has a molecular weight distribution from 1.5 to 6, and more preferably from 2.5 to 5.5, and more preferably from 3 to 5, and even more preferably from 2 to 3.5. All individual values and subranges from 1.5 to 6 are included herein and disclosed herein. In a preferred embodiment, the propylene-based interpolymer is a propylene/ethylene interpolymer. In a further embodiment, the ethylene content of the interpolymer ranges from 0.1 to 30 weight percent, preferably from 0.5 to 25 weight percent, and more preferably from 1 to 20 weight percent, based on the total weight of polymerizable monomers.

As discussed above, the propylene-based interpolymers are made using a metal-centered, heteroaryl ligand catalyst, in combination with one or more activators, for example, an alumoxane. In certain embodiments, the metal is one or more of hafnium and/or zirconium. More specifically, in certain embodiments of the catalyst, the use of a hafnium metal has been found to be preferred, as compared to a zirconium metal, for heteroaryl ligand catalysts. The catalysts, in certain embodiments, are compositions comprising the ligand and metal precursor, and, optionally, may additionally include an activator, combination of activators, or activator package.

The catalysts used to make the propylene-based interpolymers additionally include catalysts comprising ancillary ligand-hafnium complexes, ancillary ligand-zirconium complexes and optionally activators, which catalyze polymerization and copolymerization reactions, particularly with monomers that are olefins, diolefins or other unsaturated compounds. Zirconium complexes, hafnium complexes, compositions or compounds can be used. The metal-ligand complexes may be in a neutral or charged state. The ligand to metal ratio may also vary, the exact ratio being dependent on the nature of the ligand and metal-ligand complex. The metal-ligand complex or complexes may take different forms, for example, they may be monomeric, dimeric, or of an even higher order. Suitable catalyst structures and associated ligands are described in U.S. Pat. No. 6,919,407, column 16, line 6 to column 41, line 23, which is incorporated herein by reference.

In one embodiment, the propylene-based polymer comprises at least 50 weight percent propylene (based on the total amount of polymerizable monomers) and at least 5 weight percent ethylene (based on the total amount of polymerizable monomer), and has ¹³C NMR peaks, corresponding to a region error, at about 14.6 and 15.7 ppm, and the peaks are of about equal intensity (for example, see U.S. Pat. No. 6,919,407, column 12, line 64 to column 15, line 51).

The propylene-based interpolymers can be made by any convenient process. In one embodiment, the process reagents, that is, (i) propylene, (ii) ethylene and/or one or more unsaturated comonomers, (iii) catalyst, and, (iv) optionally, solvent and/or a molecular weight regulator (for example, hydrogen), are fed to a single reaction vessel of any suitable design, for example, stirred tank, loop, or fluidized-bed. The process reagents are contacted within the reaction vessel, under appropriate conditions (for example, solution, slurry, gas phase, suspension, high pressure), to form the desired polymer, and then the output of the reactor is recovered for post-reaction processing. All of the output from the reactor can be recovered at one time (as in the case of a single pass or batch reactor), or it can be recovered in the form of a bleed stream, which forms only a part, typically a minor part, of the reaction mass (as in the case of a continuous process reactor, in which an output stream is bled from the reactor, at the same rate at which reagents are added, to maintain the polymerization at steady-state conditions).

“Reaction mass” means the contents within a reactor, typically during, or subsequent to, polymerization. The reaction mass includes reactants, solvent (if any), catalyst, and products and by-products. The recovered solvent and unreacted monomers can be recycled back to the reaction vessel. Suitable polymerization conditions are described in U.S. Pat. No. 6,919,407, column 41, line 23 to column 45, line 43, incorporated herein by reference.

### Saturated Compounds

Suitable saturated compounds include hydrocarbon waxes, hydrocarbon oils, fluorinated hydrocarbons, aliphatic amides and siloxanes.

Suitable hydrocarbon waxes include paraffin wax, carbowax, beeswax, and waxes of general formula, CH₃—(CH₂)ₙ—CH₃, where each n is greater than 20, and preferably greater than 25. In one embodiment, N is from 17 to 50.

Suitable hydrocarbon oils include mineral oils, vegetable oils, petroleum oils, animal oils, and oils of general formula, CH₃—(CH₂)ₙ—CH₃, where n is less than 20. Additional oils include straight chain or branched chain paraffins, which do not contain carbon-carbon double bonds and do not contain carbon-carbon triple bonds.

Suitable fluorinated hydrocarbons include tetra fluoroethylene polymers, polyvinylidene fluoride and hexafluoropropylene.

Useful silicone compounds for use in the inventive compositions include siloxane polymers containing the structural unit general formula (I) below.

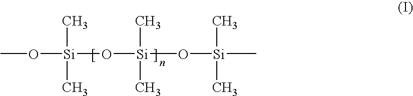

In formula (I), n is greater than, or equal to 10, preferably greater than or equal to 20. These compounds are typically end capped with an alkyl group, such as a methyl group or ethyl group, or propyl group, and typically with methyl. These compounds may also be end capped with a vinyl group, such as CH═CH₂, although such are not preferred. An example of a masterbatch of such a compound is AMPACET 101724-U, available from Ampacet.

Silicon compounds have been used by others as mold release agents, and as abrasion resistant agents (see U.S. Pat. No. 5,902,854). However, it has been discovered that silicon compounds, work well as slip agents in compositions containing the propylene-based interpolymers, as described herein, and, in addition, do not contribute negatively to taste and odor aspects of the composition, especially when exposed to ozonated water.

Additional suitable compounds include aliphatic amides, such as benhenamide (docosaamide), stearamide (octadecanamide) and ethylene-bis-stearamide.

Some suitable amides are of formula (II) below:

CH₃—(CH₂)ₙ—CONH₂ (II),

where n is greater than, or equal to, 6, preferably greater than, or equal to, 10, and more preferably greater than, or equal to, 14. In a further embodiment, n is less than, or equal to, 30, preferably less than, or equal to, 25, and more preferably less than, or equal to, 20. Additional amides include straight chain aliphatic amides, which do not contain carbon-carbon double bonds or carbon-carbon triple bonds, and branched aliphatic amides, which do not contain carbon-carbon double bonds or carbon-carbon triple bonds.

In one embodiment, the composition used to form the at least one layer, also contains a saturated compound as discussed above. This saturated compound is preferably present in an amount from 0.05 to 5.0 weight percent, preferably from 0.1 to 3.0 weight percent, more preferably from 0.5 to 2.0 weight percent, and even more preferably from 1.0 to 2.0 weight percent, based on the total weight of the composition.

### Additives

Stabilizer and antioxidants may be added to a resin formulation to protect the resin from degradation, caused by reactions with oxygen, which are induced by such things as heat, light, or residual catalyst from the raw materials. Suitable antioxidants are commercially available from Ciba-Geigy, and include Irganox® 565, 1010 and 1076, which are hindered phenolic antioxidants. These are primary antioxidants act as free radical scavengers, and may be used alone, or in combination with other antioxidants, such as phosphite antioxidants, like Irgafos® 168, available from Ciba-Geigy. Phosphite antioxidants are considered secondary antioxidants, and are not generally used alone. Phosphite antioxidants serve primarily as peroxide decomposers. Other available antioxidants include, but are not limited to, Cyanox® LTDP, available from Cytec Industries in Stamford, Conn., and Ethanox® 1330, available from Albemarle Corporation, in Baton Rouge, La. Many other antioxidants are available for use by themselves, or in combination with other such antioxidants.

Other resin additives include, but are not limited to, ultraviolet light absorbers, antistatic agents, pigments, dyes, nucleating agents, fillers, slip agents, fire retardants, plasticizers, processing aids, lubricants, stabilizers, smoke inhibitors, viscosity control agents and anti-blocking agents. Additives may also be used to modify COF, afford antifogging characteristics, to pigment the film, and/or to alter film permeability. The film may be surface treated for printing. In one embodiment, the film compositions do not contain an adhesive

In certain embodiments, the propylene-based interpolymers may be blended with other materials, which include recycled and scrap materials and diluent polymers, to the extent that the improved sealant properties are maintained. Examples include other polymers, such as PP or RCP PP resins (to modify cost), polyethylene resins (for example, LDPE for improved bubble stability or LLDPE for improved impact strength), polybutene (PB), anhydride modified polyethylenes, HDPE, ethylene/acrylic acid (EAA), ethylene ethyl-acrylate (EEA), ethylene methacrylate (EMA), ethylene vinyl acetate (EVA), and combinations thereof. In other embodiments, the propylene-based interpolymers may also be blended into an inner or core layer to further soften the film, and to improve low temperature shrink and reduce shrink tension. Propylene-based interpolymers can also be added to one or more layers in a blend to improve the softness, bubble stability and shrink performance of the film.

### Preferred Films

Preferred films (or film compositions) contain at least one layer formed from a composition containing one or more propylene-based interpolymers as discussed above, and more preferably one or more propylene/ethylene interpolymers, as discussed above. Preferably the one or more interpolymer is/are present from 50 to 99.9 weight percent, more preferably from 60 to 99.5 weight percent, and even more preferably from 77 to 99 weight percent (based on the total weight of the composition used to form the at least one layer).

In another embodiment, the composition, used to form the at least one layer, also contains a siloxane component as discussed above. This siloxane component is preferably present in an amount from 0.1 to 3.0 weight percent, more preferably from 0.5 to 2.0 weight percent, and even more preferably from 1.0 to 2.0 weight percent, based on the total weight of the composition. Optionally, the composition may also contain an antiblock, such as a diatomaceous earth, and preferably, this component is present in an amount from 0 to 2.0 weight percent. In addition, the composition may optionally contain a processing aid, such as a fluoropolymer-based processing aid, and preferably this component is present in an amount from 0 to 0.15 weight percent, based on the total weight of the composition.

In another embodiment, the film composition contains at least three layers. In a further embodiment, a HDPE is sandwiched between two films, wherein an outer (interior) layer is formed from an inventive composition. In another embodiment, both outer layers (interior and exterior) are each, independently formed from an inventive composition, and preferably both are formed from the same inventive composition. In a further embodiment, the film composition is formed from a coextrusion process.

In another embodiment, a propylene homopolymer is sandwiched between two films, wherein an outer (interior) layer is formed from an inventive composition. In another embodiment, both outer layers (interior and exterior) are each, independently formed from an inventive composition, and preferably both are formed from the same inventive composition. In a further embodiment, the film composition is formed from a coextrusion process.

In another embodiment, a propylene-based polymer, and preferably a propylene-based interpolymer, is sandwiched between two films, wherein an outer (interior) layer is formed from an inventive composition. In another embodiment, both outer layers (interior and exterior) are each, independently formed from an inventive composition, and preferably both are formed from the same inventive composition. In a further embodiment, the film composition is formed from a coextrusion process. In another embodiment, the propylene-based polymer is an INSPIRE™ polymer, available from The Dow Chemical Company.

In a preferred embodiment, the invention provides a film comprising at least three layers, and preferably three consecutive layers, such as A/B/A. In a further embodiment, film consists of three layers, such as A/B/A.

In one embodiment, the two outer layers are formed from the same inventive composition (Composition A). The invention also provides a film pouch formed from one of the above films.

In one embodiment, inventive Composition A comprises at least one polymer selected from a propylene-based interpolymer, as described herein. In a further embodiment, the propylene-based interpolymer is a propylene/ethylene interpolymer, as described herein. In a further embodiment, the propylene/ethylene interpolymer has a density from 0.86 g/cc to 0.89 g/cc, and preferably from 0.865 g/cc to 0.880 g/cc. In another embodiment, the propylene/ethylene interpolymer has a melt flow rate (MFR) from 0.5 g/10 min to 15 g/10 min, and preferably from 2 g/10 min to 8 g/10 min. The propylene/ethylene interpolymer may have a combination of two or more embodiments as described herein. The invention also provides a film pouch formed from one of the above films.

In another embodiment, inventive Composition A further comprises a siloxane polymer. In another embodiment, Composition A further comprises a fluoropolymer. In another embodiment, Composition A further comprises diatomaceous earth. Composition A may comprise a combination of two or more of these embodiments. The invention also provides a film pouch formed from one of these films.

In another embodiment Composition A does not contain an unsaturated slip agent and does not contain a linear low density ethylene/α-olefin interpolymer, and does not contain a low density polyethylene (LDPE). In another embodiment Composition A does not contain an unsaturated slip agent and/or does not contain a linear low density ethylene/α-olefin interpolymer and/or a low density polyethylene (LDPE).

In another embodiment, the inner layer of the film formed from three layers, A/B/A, is formed from the same composition (Composition B) comprising at least one polymer selected from a high density polyethylene (HDPE), a medium density polyethylene (MDPE), propylene-based interpolymer, propylene homopolymer, impact modified polypropylene, a linear low density polyethylene (LLDPE), and combinations thereof. In another embodiment, the inner layer of the film formed from three layers, A/B/A, is formed from the same composition (Composition B) comprising at least one polymer selected from a high density polyethylene (HDPE), a medium density polyethylene (MDPE), propylene-based interpolymer, propylene homopolymer, and combinations thereof.

The high density polyethylene preferably has a density from 0.94 g/cc to 0.96 g/cc. The medium density polyethylene preferably has a density from 0.93 g/cc to 0.94 g/cc. The linear low density polyethylene preferably has a density from 0.90 g/cc to 0.94 g/cc. In another embodiment, the linear low density polyethylene is formed from a gas phase process. In another embodiment, the linear low density polyethylene is an ethylene/hexene copolymer of an ethylene/butene copolymer, and preferably those copolymers formed from a solution process.

Composition B may comprise a combination of two or more of these embodiments. The invention also provides a film pouch formed from one of the above films.

In another embodiment, the film comprises at least two layer B/A. In a further embodiment, each layer is formed from Composition A or Composition B, each as described above.

In another embodiment, the film comprises three layers, C/B/A, where layer C can have the same composition as Composition B or Composition A, or any polymers or blends, and preferably polymers and blends suitable for extrusion processes.

In a further embodiment, the composition used to form Layer C can also comprises one or more additives, such as slip, antiblock, processing aid, combinations thereof, or any other additive material useful for extrusion

In one embodiment, the film is formed by a coextrusion process.

In one embodiment, the A/B/A film has a thickness ratio of 20/60/20.

In another embodiment the film has a thickness from 2 to 4 mils.

A film may comprise a combination of two or more of the above embodiments. The invention also provides a pouch formed from one of the above films.

In another embodiment, the film comprises a multilayered A/B/A structure as shown in Table A below.

TABLE A
Multilayer Film Structure

| | 1 | 2 |
|---|---|---|
| LAYER A | | |
| V22 | 81 | 81 |
| Ampacet 101724-U | 15 | 15 |
| AB | 3 | 3 |
| PA | 1 | 1 |
| LAYER B | | |
| HDPE-64 | 100 | |
| rPP 6D | | 100 |

See Experimental Section for Descriptions

In another embodiment, “HDPE-64” of Table A is substituted with at least one polymer selected from a high density polyethylene (HDPE), a medium density polyethylene (MDPE), a linear low density polyethylene (LLDPE), and combinations thereof. The high density polyethylene preferably has a density from 0.94 g/cc to 0.96 g/cc. The medium density polyethylene preferably has a density from 0.93 g/cc to 0.94 g/cc. The linear low density polyethylene preferably has a density from 0.90 g/cc to 0.94 g/cc. In another embodiment, the linear low density polyethylene is formed from a gas phase process. In another embodiment, the linear low density polyethylene is an ethylene/hexane copolymer of an ethylene/butene copolymer, and preferably those copolymers formed from a solution process.

In another embodiment, “rPP 6D” of Table A is substituted with at least one polymer selected from a propylene homopolymer, a propylene random copolymer, a propylene impact copolymer, or combinations thereof.

In another embodiment Composition A does not contain an unsaturated slip agent and does not contain a linear low density ethylene/α-olefin interpolymer, and does not contain a low density polyethylene (LDPE). In another embodiment Composition A does not contain an unsaturated slip agent and/or does not contain a linear low density ethylene/α-olefin interpolymer and/or a low density polyethylene (LDPE).

In another embodiment, the film comprises two layer B/A with at least two layers as defined in Table A.

In another embodiment, the film comprises three layers, C/B/A, where layer C can have the same as layers B or A, as described in Table A, or any polymers or blends, and preferably polymers and blends suitable for extrusion processes. In a further embodiment, the composition used to form Layer C can also comprises one or more additives, such as slip, antiblock, processing aid, combinations thereof, or any other additive material useful for extrusion

In one embodiment, the film is formed by a coextrusion process.

In one embodiment, the A/B/A film has a thickness ratio of 20/60/20.

In another embodiment the film has a thickness from 2 to 4 mils.

A film may comprise a combination of two or more of the above embodiments. The invention also provides a film pouch formed from one of the above films.

The ratio of the layers as well as the film thickness could vary to provide the adequate stiffness, mechanical properties, and sealing properties desired for the application.

Preferred range for the layer (A): 10% to 30%, or 5 to 16 μm
Preferred film thickness: 2-10 mils (or as specified in previous application for monolayer film).

A film may comprise a combination of two or more of the above embodiments. The invention also provides a film pouch formed from one of the above films.

### Preparation of Film

A film (or film composition) of the invention can be prepared by selecting the polymers suitable for making each layer, forming a film of each layer, and bonding the layers, or coextruding or casting one or more layers. Desirably, the film layers are bonded continuously over the interfacial area between film layers.

In a preferred embodiment, the inventive films are formed using a blown film process or a cast film process. In another embodiment, the films are formed using a double bubble process. Films may be oriented using procedures known in the art, such as an “in-line” or an “off-line” stretching apparatus.

The propylene-based interpolymers can be used in neat form or in blends, in either the outer layer(s) or the core layer, depending on the balance of properties required. The inventive film may be used in existing forms. The films can also be printed and used for packaging purposes. In certain embodiments the films may be laminated to other substrates to produce laminates with specific property requirements (for example, a PET//BOPE for temperature resistance/differential and modulus, or a PA//BOPE for impact strength and barrier, or a PET//PA//BOPE or a BOPP//BOPE, or SiOx (silicon oxide) coated films). In certain embodiments, the films may also be metallized to improve the O₂TR and water vapor barrier. In other embodiments, the films may also be coextruded with barrier materials, such as polyvinylidene barrier resins or polyamides or EVOH resins.

Other layers may include, but are not limited to, barrier layers, as discussed above, and/or tie layers, and/or structural layers. These layers may be added to a multilayer film structure by coextrusion or by lamination techniques. Various materials can be used for these layers, with some of them being used as more than one layer in the film structure. Representative materials include: foil; polyamide, such as nylon; polyester; ethylene/vinyl alcohol (EVOH) copolymers; polyvinylidene chloride (PVDC); polyethylene terepthalate (PET); oriented polypropylene (OPP) (more especially, biaxially oriented polypropylene); ethylene/vinyl acetate (EVA) copolymers; ethylene/acrylic acid (EM) copolymers; ethylene/methacrylic acid (EMAA) copolymers; SiOₓ coated films; PVDC coated films; ULDPE; LLDPE; HDPE; MDPE; LMDPE; LDPE; ionomers; graft-modified polymers (for example, maleic anhydride grafted polyethylene); and paper. Generally, the multilayer structure of the present invention may comprise from two to about seven layers.

For each layer, typically, it is suitable to extrusion blend, melt blend or dry blend the components and any additional additives, such as stabilizers and polymer processing aids. The extrusion blending should be carried out in a manner, such that an adequate degree of dispersion is achieved. The parameters of extrusion blending will necessarily vary, depending upon the components. However, typically, the total polymer deformation, that is, mixing degree, is important, and is controlled by, for example, the screw-design and the melt temperature. The melt temperature during film forming will depend on the film components.

After extrusion blending, a film structure is formed. Film structures may be made by conventional fabrication techniques, for example, bubble extrusion, biaxial orientation processes (such as tenter frames or double bubble processes), cast/sheet extrusion, coextrusion and lamination. Conventional bubble extrusion processes (also known as hot blown film processes) are described, for example, in The Encyclopedia of Chemical Technology, Kirk-Othmer, Third Edition, John Wiley & Sons, New York, 1981, Vol. 16, pp. 416-417 and Vol. 18, pp. 191-192. Biaxial orientation film manufacturing processes, such as described in the “double bubble” process of U.S. Pat. No. 3,456,044 (Pahlke), and the processes described in U.S. Pat. No. 4,352,849 (Mueller), U.S. Pat. Nos. 4,820,557 and 4,837,084 (both to Warren), U.S. Pat. No. 4,865,902 (Golike et al.), U.S. Pat. No. 4,927,708 (Herran et al.), U.S. Pat. No. 4,952,451 (Mueller), and U.S. Pat. Nos. 4,963,419 and 5,059,481 (both to Lustig et al.), can also be used to make the novel film structures of this invention. All of these patents are incorporated herein by reference.

Other film manufacturing techniques are disclosed in U.S. Pat. No. 6,723,398 (Chum et al.). Post processing techniques, such as radiation treatment and corona treatment, especially for printing applications, can also be accomplished with the materials of the invention.

After the film composition has been formed, it can be stretched. The stretching can be accomplished in any manner, conventionally used in the art. Film compositions can be sent to a converter for bag manufacturing. Sheets of the film composition can be bonded by heat sealing or by use of an adhesive. Heat sealing can be effected using conventional techniques, including, but not limited to, a hot bar, impulse heating, side welding, ultrasonic welding, or other alternative heating mechanisms, as discussed above.

The film compositions of the aforementioned processes may be made to any thickness depending upon the application. Typically the film compositions have a total thickness of from 5 to 1000 microns, preferably from 10 to 500 microns, more preferably from 12 to 100 microns. The permeability may also be adjusted depending upon the application.

### Applications

The inventive compositions are particularly suitable in the formation of single layered or multi-layered films.

The single or multilayer film may find utility in a variety of applications. Preferred applications, which make use of the film's improved sealing properties and good stiffness, include, pouches for packaging flowable material (especially pouches made using vertical form-fill-seal equipment), heavy-duty shipping sacks and overwrap film. Other applications include, but are not limited to, multilayer or monolayer packaging structures, where the structure is oriented (preferably biaxially oriented) for shrink film and barrier shrink applications; cook-in packaged foods; liners (such as cap liners); gaskets and lidding stock; bags; bottles; and caps.

The film structure comprises one, two, or three or more layers. In one embodiment, the film structure is a three layer structure with a propylene-based polymer layer, as a core layer, interposed between a layer formed from an inventive composition and an outer layer. Other suitable core layers can be formed from a HDPE, a polypropylene homopolymer, a propylene-based interpolymer, and an INSPIRE™ polymer (available from the Dow Chemical Company). The outer may be formed from an ethylene-based polymer, a propylene-based polymer, HDPE, VERSIFY™ polymer, a polyester, such as polyethylene terephthalate (PET), or other suitable polymers.

As discussed above, some suitable three-layered films include the following structures: (a) inv. film/HDPE/inv. film, (b) inv. film/rPP/inv. film and (c) inv. film/hPP/inv. film; where “inv. film” refers to “inventive film (or film formed from an inventive composition),” “rPP” refers to random propylene interpolymer, and “hPP” refers to propylene homopolymer.

A multilayer film structure of the invention may any thickness, required in its intended use. Preferably, however, the total thickness is in the range from 0.25 mil to 50 mils, more preferably in the range of from 0.4 mils to 40 mils, and even more preferably from 1 mils to 10 mils. The sealant layer (and an outer layer, if present, such as in a three layer structure) may preferably constitute from about 2 to about 50 percent of the total film thickness, more preferably from about 10 to 45 percent of the total film thickness.

Although not required, adhesion promoting tie layers (such as PRIMACOR™ ethylene-acrylic acid (EAA) copolymers, available from The Dow Chemical Company, and/or ethylene-vinyl acetate (EVA) copolymers, as well as additional structural layers (such as AFFINITY™ polyolefin plastomers, available from The Dow Chemical Company, ENGAGE™ polyolefin elastomers, available from The Dow Chemical Company, DOWLEX™ LLDPE, available from The Dow Chemical Company, ATTANE™ ULDPE, available from The Dow Chemical Company, or blends of any of these polymers, with each other, or with another polymer, such as EVA), may be optionally employed.

As discussed above, other layers including, but are not limited to, barrier layers, and/or tie layers, and/or structural layers may be added to the multilayer film structure by coextrusion or by lamination techniques. Various materials can be used for these layers, with some of them being used as more than one layer in the film structure. Representative materials include: foil, nylon, ethylene/vinyl alcohol (EVOH) copolymers, polyvinylidene chloride (PVDC), polyethylene terepthalate (PET), oriented polypropylene (OPP) (more especially, biaxially oriented polypropylene), ethylene/vinyl acetate (EVA) copolymers, ethylene/acrylic acid (EM) copolymers, ethylene/methacrylic acid (EMAA) copolymers, SiOx coated films, PVDC coated films, ULDPE, LLDPE, HDPE, MDPE, LMDPE, LDPE, ionomers, graft-modified polymers (for example, maleic anhydride grafted polyethylene), and paper. Generally, the multilayer structure of the present invention may comprise from two to about seven layers.

Multilayer film manufacturing techniques are described in The Encyclopedia of Chemical Technology, Kirk-Othmer, Third Edition, John Wiley & Sons, New York, 1981, Vol. 16, pp. 416-417 and Vol. 18, pp. 191-192; Packaging Foods With Plastics, by Wilmer A. Jenkins and James P. Harrington (1991), pp. 19-27; “Coextrusion Basics” by Thomas I. Butler, Film Extrusion Manual: Process, Materials, Properties pp. 31-80 (published by TAPPI Press (1992)); “Coextrusion For Barrier Packaging,” by W. J. Schrenk and C. R. Finch, Society of Plastics Engineers RETEC Proceedings, Jun. 15-17, 1981, pp. 211-229; K. R. Osborn and W. A. Jenkins; and Plastic Films, Technology and Packaging Applications (Technomic Publishing Co., Inc. (1992)), the disclosure of each is incorporated herein by reference.

After fabrication, the multilayer film of the present invention may be oriented (off-line or in a continuous operation) using methods and procedures well known in the art. Biaxial orientation processes, such as tenter frames, “trapped bubble” and “double bubble” processes, can be used to orient the film. Suitable techniques are described in U.S. Pat. No. 3,456,044 (Pahike); U.S. Pat. No. 4,865,902 (Golike et al.); U.S. Pat. No. 4,352,849 (Mueller); U.S. Pat. No. 4,820,557 (Warren); U.S. Pat. No. 4,927,708 (Herran et al.); U.S. Pat. No. 4,963,419 (Lustig et al.); and U.S. Pat. No. 4,952,451 (Mueller), the disclosure of each is incorporated herein by reference.

The invention provides a pouch comprising at least one film layer formed from an inventive composition.

In one embodiment, the pouch is formed from a film composition in the shape of a rectangle, and wherein the shorter ends of the rectangle are sealed together to form a cylinder. The cylinder is then sealed at both open ends to form a pouch.

In another embodiment, a pouch is formed by sealing the shorter ends of two rectangular surface areas of the same dimensions to form an open bag-like structure. The top end of the structure is also sealed, and a third piece of film is inserted into the periphery of the lower end, and sealed along the perimeter of the lower end.

Film pouch designs suitable for use in the invention include commercially available pouches used to contain fruit drinks and other beverages. Such pouches are commonly sold in grocery stores.

### DEFINITIONS

Any numerical range recited herein, include all values from the lower value to the upper value, in increments of one unit, provided that there is a separation of at least 2 units between any lower value and any higher value. As an example, if it is stated that the amount of a component, or a value of a compositional or physical property, such as, for example, amount of a blend component, melting temperature, melt index, etc., is between 1 and 100, it is intended that all individual values, such as, 1, 2, 3, etc., and all subranges, such as, 1 to 20, 55 to 70, 197 to 100, etc., are expressly enumerated in this specification. For values which are less than one, one unit is considered to be 0.0001, 0.001, 0.01 or 0.1, as appropriate. These are only examples of what is specifically intended, and all possible combinations of numerical values between the lowest value and the highest value enumerated, are to be considered to be expressly stated in this application. Numerical ranges have been recited, as discussed herein, in reference to melt flow rate, density, weight percent of a component, and other properties.

The term “about,” as used herein, in reference to a given numerical value, refers to values within ±10% of the given numerical value, unless otherwise stated.

The term “film composition,” as used herein, means a layered film structure. The term “film composition” is equivalent to the term “film,” when the term “film” is in referenced to a layered film structure.

The term “composition,” as used herein, includes a mixture of materials which comprise the composition, as well as reaction products and decomposition products formed from the materials of the composition.

The term “polymer,” as used herein, refers to a polymeric compound prepared by polymerizing monomers, whether of the same or a different type. The generic term polymer thus embraces the term homopolymer, usually employed to refer to polymers prepared from only one type of monomer, and the term interpolymer as defined hereinafter.

The term “interpolymer,” as used herein, refers to polymers prepared by the polymerization of at least two different types of monomers. The generic term interpolymer thus includes copolymers, usually employed to refer to polymers prepared from two different types of monomers, and polymers prepared from more than two different types of monomers.

The term “ethylene-based polymer,” as used herein, refers to a polymer that comprises greater than 50 mole percent polymerized ethylene monomers (based on the total moles of polymerizable monomers).

The term “ethylene-based interpolymer,” as used herein, refers to a polymer that comprises greater than 50 mole percent polymerized ethylene monomers (based on the total moles of polymerizable monomers), and at least one comonomer.

The term, “propylene-based polymer,” as used herein, refers to a polymer that comprises greater than 50 mole percent polymerized propylene monomers (based on the total moles of polymerizable monomers).

The term, “propylene-based interpolymer,” as used herein, refers to a polymer that comprises greater than 50 mole percent polymerized propylene monomers (based on the total moles of polymerizable monomers), and at least one comonomer.

The terms “blend” or “polymer blend,” as used herein, mean a blend of two or more polymers. Such a blend may or may not be miscible (not phase separated at the molecular level). Such a blend may or may not be phase separated. Such a blend may or may not contain one or more domain configurations, as determined from transmission electron microscopy, light scattering, x-ray scattering, and other methods known in the art.

The term “saturated compound,” as used herein, refers to small molecules, oligomers and polymers, which each does not contain a carbon-carbon double bond, and does not contain a carbon-carbon triple bond.

### Test Procedures

The densities of the propylene-based polymers and the ethylene-based polymers are measured in accordance with ASTM D-792-00. ASTM D-792-00 can also be used to measure density of other polymers as noted in this test.

The melt flow rate (MFR) of an propylene-based polymer is measured in accordance with ASTM D-1238-04, condition 230° C./2.16 kg. Melt index (12) of an ethylene-based polymer is measured in accordance with ASTM D-1238-04, condition 190° C./2.16 kg.

### Gel Permeation Chromatography

Molecular weight distribution of the polymers can be determined using Gel Permeation Chromatography (GPC) on a Polymer Laboratories PL-GPC-220 high temperature chromatographic unit, equipped with four linear, mixed bed columns (Polymer Laboratories (20-micron particle size)). The oven temperature is at 160° C., with the auto sampler hot zone at 160° C., and the warm zone at 145° C. The solvent is 1,2,4-trichlorobenzene containing 200 ppm 2,6-di-t-butyl-4-methylphenol. The flow rate is 1.0 milliliter/minute, and the injection size is 100 microliters. About 0.2 percent by weight solutions of the samples are prepared for injection, by dissolving the sample in nitrogen purged 1,2,4-trichlorobenzene, containing 200 ppm 2,6-di-t-butyl-4-methylphenol, for 2.5 hrs at 160° C., with gentle mixing.

The molecular weight determination is deduced by using ten narrow molecular weight distribution polystyrene standards (from Polymer Laboratories, EasiCal PSI, ranging from 580-7,500,000 g/mole) in conjunction with their elution volumes. The equivalent polypropylene molecular weights are determined by using appropriate Mark-Houwink coefficients for polypropylene (as described by Th. G. Scholte, N. L. J. Meijerink, H. M. Schoffeleers, and A. M. G. Brands, J. Appl. Polym. Sci., 29, 3763-3782 (1984)), and polystyrene (as described by E. P. Otocka, R. J. Roe, N.Y. Hellman, P. M. Muglia, Macromolecules, 4, 507 (1971)) in the Mark-Houwink equation:

{N}=KM^{a},

where Kₚₚ=1.90E-04, aₚₚ=0.725, Kₚₛ=1. 26E-04, and aₚₛ=0.702.

### Differential Scanning Calorimetry

Differential scanning calorimetry (DSC) is a common technique that can be used to examine the melting and crystallization of semi-crystalline polymers. General principles of DSC measurements, and applications of DSC to studying semi-crystalline polymers, are described in standard texts (for example, E. A. Turi, ed., Thermal Characterization of Polymeric Materials, Academic Press, 1981). Certain of the interpolymers of this invention are characterized by a DSC curve, with a Tₘₑ that remains essentially the same, and a T_{Max} that decreases as the amount of unsaturated comonomer in the interpolymer is increased. The Tme refers to the temperature at which the melting ends. The T_{Max} refers to the peak melting temperature.

Differential Scanning Calorimetry (DSC) analysis is determined using a model Q1000 DSC from TA Instruments, Incorporated. The calibration of the DSC is done as follows. First, a baseline is obtained by running the DSC from −90° C. to 290° C., without any sample in the aluminum DSC pan. Then seven milligrams of a fresh indium sample is analyzed by heating the sample to 180° C., cooling the sample to 140° C., at a cooling rate of 10° C./min, followed by keeping the sample isothermally at 140° C. for one minute, followed by heating the sample from 140° C. to 180° C., at a heating rate of 10° C./min. The heat of fusion and the onset of melting of the indium sample are determined, and checked to be within 0.5° C., from 156.6° C. for the onset of melting, and within 0.5 J/g, from 28.71 J/g for the heat of fusion. Then deionized water is analyzed by cooling a small drop of fresh sample in the DSC pan from 25° C. to −30° C., at a cooling rate of 10° C./min. The sample is kept isothermally at −30° C. for two minutes, and heated to 30° C., at a heating rate of 10° C./min. The onset of melting is determined and checked to be within 0.5° C. from 0° C.

The propylene-based samples are pressed into a thin film at a temperature of 190° C. About five to eight milligrams of sample is weighed out, and placed in the DSC pan. The lid is crimped on the pan to ensure a closed atmosphere. The sample pan is placed in the DSC cell, and heated at a high rate of about 100° C./min, to a temperature of about 30° C. above the melt temperature. The sample is kept at this temperature for about 3 minutes. Then the sample is cooled at a rate of 10° C./min, to −40° C., and kept isothermally at that temperature for three minutes. Consequently the sample is heated at a rate of 10° C./min, until complete melting. The resulting enthalpy curves are analyzed for peak melt temperature, onset and peak crystallization temperatures, heat of fusion and heat of crystallization, Tme, and any other DSC parameters of interest. See also U.S. Pat. No. 6,919,407, column 61, line 24 to column 65, line 55, incorporated herein by reference.

### 13C NMR

The 13C NMR spectroscopy is one of a number of techniques known in the art of measuring comonomer incorporation into a polymer. An example of this technique is described for the determination of comonomer content for ethylene/α-olefin copolymers in Randall (Journal of Macromolecular Science, Reviews in Macromolecular Chemistry and Physics, C29 (2 & 3), 201-317 (1989)). The basic procedure for determining the comonomer content of an olefin interpolymer involves obtaining the ¹³C NMR spectrum under conditions where the intensity of the peaks, corresponding to the different carbons in the sample, is directly proportional to the total number of contributing nuclei in the sample. Methods for ensuring this proportionality are known in the art, and involve allowance for sufficient time for relaxation after a pulse, the use of gated-decoupling techniques, relaxation agents, and the like. See also U.S. Pat. No. 6,919,407, columns 13-15, incorporated herein by reference.

The relative intensity of a peak, or group of peaks, is obtained in practice from its computer-generated integral. After obtaining the spectrum and integrating the peaks, those peaks associated with the comonomer are assigned. This assignment can be made by reference to known spectra or literature, or by synthesis and analysis of model compounds, or by the use of isotopically labeled comonomer. The mole percent comonomer can be determined by the ratio of the integrals corresponding to the number of moles of comonomer to the integrals corresponding to the number of moles of all of the monomers in the interpolymer, as described in Randall, for example.

The data is collected using a Varian UNITY Plus 400 MHz NMR spectrometer, corresponding to a 13C resonance frequency of 100.4 MHz. Acquisition parameters are selected to ensure quantitative 13C data acquisition in the presence of the relaxation agent. The data is acquired using gated 1H decoupling, 4000 transients per data file, a 7 sec pulse repetition delay, spectral width of 24,200 Hz, and a file size of 32K data points, with the probe head heated to 130° C. The sample is prepared by adding approximately 3 mL of a 50/50 mixture of tetrachloroethane-d2/orthodichlorobenzene that is 0.025M in chromium acetylacetonate (relaxation agent) to 0.4 g sample in a 10 mm NMR tube. The headspace of the tube is purged of oxygen by displacement with pure nitrogen. The sample is dissolved and homogenized by heating the tube and its contents to 150° C., with periodic refluxing initiated by heat gun. Following data collection, the chemical shifts are internally referenced to the mmmm pentad at 21.90 ppm.

For propylene/ethylene copolymers, the following procedure is used to calculate the percent ethylene in the polymer. Integral regions are determined as shown in Tables 1 and 2.

TABLE 1
Integral Regions for Determining Percent Ethylene

| Region designation | PPM |
|---|---|
| A | 44-49 |
| B | 36-39 |
| C | 32.8-34 |
| P | 31.0-30.8 |
| Q | Peak at 30.4 |
| R | Peak at 30 |
| F | 28.0-29.7 |
| G | 26-28.3 |
| H | 24-26 |
| I | 19-23 |

Region D is calculated as D=P−(G−Q)/2. Region E=R+Q+(G−Q)/2.

TABLE 2
Calculation of Region D

PPP = (F + A − 0.5 D)/2
PPE = D
EPE = C
EEE = (E − 0.5 G)/2
PEE = G
PEP = H
Moles P = sum P centered triads
Moles E = sum E centered triads
Moles P = (B + 2A)/2
Moles E = (E + G + 0.5B + H)/2

The C2 values are calculated as the average of the two methods above (triad summation and algebraic) although the two methods do not usually vary.

The mole fraction of propylene insertions resulting in regio-errors is calculated as one half of the sum of the two of methyls, showing up at 14.6 and 15.7 ppm, divided by the total methyls at 14-22 ppm attributable to propylene. The mole percent of the regio-error peaks is the mole fraction times 100.

Isotacticity at the triad level (mm) is determined from the integrals of the mm triad (22.70-21.28 ppm), the mr triad (21.28-20.67 ppm) and the rr triad (20.67-19.74). The mm isotacticity is determined by dividing the intensity of the mm triad by the sum of the mm, mr, and rr triads. For ethylene copolymers the mr region is corrected by subtracting 37.5-39 ppm integral. For copolymers with other monomers that produce peaks in the regions of the mm, mr, and rr triads, the integrals for these regions are similarly corrected by subtracting the intensity of the interfering peak using standard NMR techniques, once the peaks have been identified. This can be accomplished, for example, by analysis of a series of copolymers of various levels of monomer incorporation, by literature assignments, by isotopic labeling, or by other means which are known in the art.

The 13C NMR peaks corresponding to a regio-error at about 14.6 and about 15.7 ppm are believed to be the result of stereoselective 2,1-insertion errors of propylene units into the growing polymer chain. In a typical P/E* polymer, these peaks are of about equal intensity, and they represent about 0.02 to about 7 mole percent of the propylene insertions into the homopolymer or copolymer chain. For some embodiments, they represent about 0.005 to about 20 mole percent or more of the propylene insertions. In general, higher levels of regio-errors lead to a lowering of the melting point and the modulus of the polymer, while lower levels lead to a higher melting point and a higher modulus of the polymer.

### Temperature-Rising Elution Fractionation

The determination of crystallizable sequence length distribution can be accomplished on a preparative scale by temperature-rising elution fractionation (TREF). The relative mass of individual fractions can be used as a basis for estimating a more continuous distribution. L. Wild, et al., Journal of Polymer Science: Polymer. Physics Ed., 20, 441 (1982), scaled down the sample size and added a mass detector to produce a continuous representation of the distribution as a function of elution temperature. This scaled down version, analytical temperature-rising elution fractionation (ATREF), is not concerned with the actual isolation of fractions, but with more accurately determining the weight distribution of fractions.

While TREF was originally applied to interpolymers of ethylene and higher α-olefins, it can also be used for the analysis of interpolymers of propylene with ethylene (or higher α-olefins). The analysis of interpolymers of propylene requires higher temperatures for the dissolution and crystallization of pure, isotactic polypropylene, but most of the copolymerization products of interest elute at similar temperatures, as observed for interpolymers of ethylene. Table 3 is a summary of conditions used for the analysis of copolymers of propylene. Except as noted the conditions for TREF are consistent with those of Wild, et al., ibid, and Hazlitt, Journal of Applied Polymer Science: Appl. Polym. Symp., 45, 25 (1990).

TABLE 3
Parameters Used for TREF

| Parameter | Explanation |
|---|---|
| Column type and size | Stainless steel shot with 1.5 cc interstitial |
| | volume |
| Mass detector | Single beam infrared detector at 2920 cm⁻¹ |
| Injection temperature | 150° C. |
| Temperature control device | GC oven |
| Solvent | 1,2,4-trichlorobenzene |
| Concentration | 0.1 to 0.3% (weight/weight) |
| Cooling Rate 1 | 140° C. to 120° C. @ −6.0° C./min |
| Cooling Rate 2 | 120° C. to 44.5° C. @ −0.1° C./min |
| Cooling Rate 3 | 44.5° C. to 20° C. @ −0.3° C./min |
| Heating Rate | 20° C. to 140° C. @ 1.8° C./min |
| Data acquisition rate | 12/min |

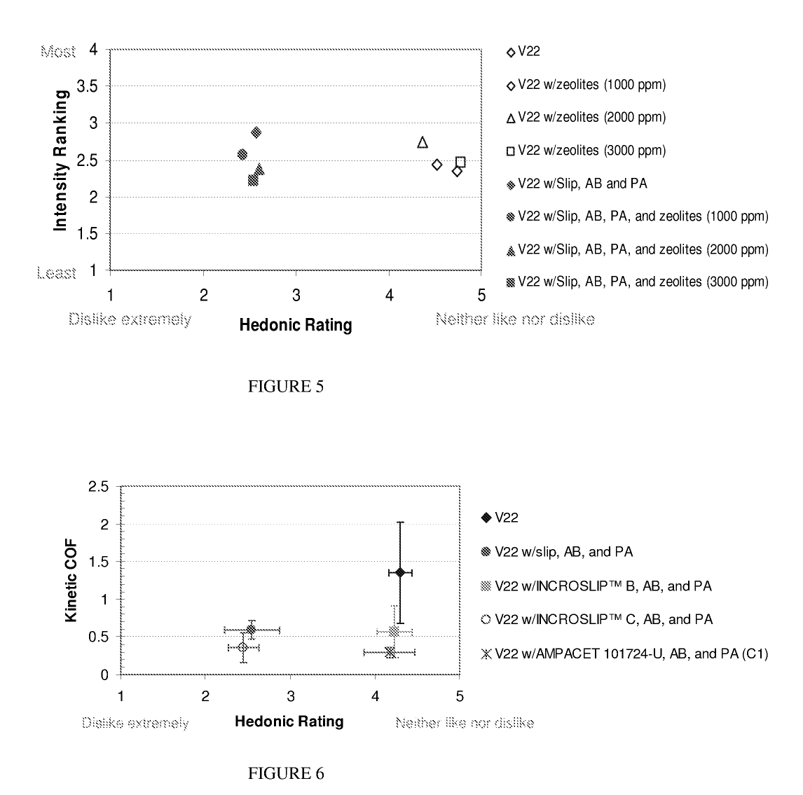

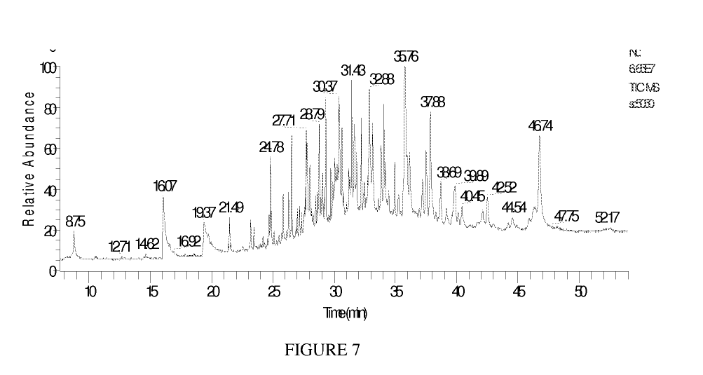

The data obtained from TREF are expressed as a normalized plot of weight fraction as a function of elution temperature. The separation mechanism is analogous to that of copolymers of ethylene, whereby the molar content of the crystallizable component (ethylene) is the primary factor that determines the elution temperature. In the case of copolymers of propylene, it is the molar content of isotactic propylene units that primarily determines the elution temperature. FIG. 5 of U.S. Pat. No. 6,919,407, incorporated herein by reference, is a representation of the typical type of distribution one would expect for a propylene/ethylene copolymer made with a metallocene polymer and an example of a P/E* copolymer.

The shape of the metallocene curve in FIG. 5 in U.S. Pat. No. 6,919,407 is typical for a homogeneous copolymer. The shape arises from the inherent, random incorporation of comonomer. A prominent characteristic of the shape of the curve is the tailing at lower elution temperature, compared to the sharpness or steepness of the curve at the higher elution temperatures. A statistic that reflects this type of asymmetry is skewness. The equation below, mathematically represents the skewness index, Sᵢₓ, as a measure of this asymmetry (see U.S. Pat. No. 6,919,407, column 11, lines 15-23, incorporated herein by reference).

Sᵢₓ={Summation of [wᵢ×(Tᵢ−T_{MAX})³]}^{1/3}÷{Summation of [wᵢ×(Tᵢ−T_{MAX})²]}^{1/2}

The value, T_{MAX}, is defined as the temperature of the largest weight fraction eluting between 50° C. and 90° C. in the TREF curve. The Tᵢ and wᵢ are the elution temperature and weight fraction, respectively, of an arbitrary, ith fraction in the TREF distribution. The distributions have been normalized (the sum of the wᵢ equals 100%) with respect to the total area of the curve eluting above 30° C. Thus, the index reflects only the shape of the crystallized polymer, and any uncrystallized polymer (polymer still in solution at or below 30° C.) has been omitted from the calculation shown in the above equation for “Sᵢₓ” (see U.S. Pat. No. 6,919,407, columns 9-11, incorporated herein by reference).

### X-Ray Diffraction

Crystal phases of polymers can be identified with X-ray diffraction (XRD), as different crystal phase has different diffraction peaks. Alpha crystal phase is most commonly seen in PP. When gamma phase coexists, its diffraction peak at about 20 degree (2-theta and copper radiation) can be visualized. The relative amount of different phases can also be evaluated based on the diffraction data.

The samples can be analyzed using a GADDS system from BRUKER-AXS, with a multi-wire, two-dimensional HiStar detector. Samples are aligned with a laser pointer and a video-microscope. Data is collected using copper radiation with a sample to detector distance of 6 cm. X-ray beam is collimated to 0.3 mm. A film sample is cut to fit the XRD sample holder and aligned on the holder.

### Heat Seal and Hot Tack Methods

Hot tack measurements were performed according to ASTM F-1921, which measures the force required to separate a heat seal before the seal has had a chance to fully cool (crystallize). This test simulates the filling of material into a pouch or bag before the seal has had a chance to completely cool. A JB instrument Hot Tack Tester, which makes seals at various seal bar temperatures, and measures the force of separation utilizing a transducer, was used with the following parameters.

### Specimen Width: 25.4 mm (1.0 in)

Sealing Pressure: 0.27 N/mm2 (40 psi)

### Sealing Dwell Time: 0.5 s

Delay time: 0.1 s
Peel speed: 200 mm/s
Number of samples per temperature: 5

Heat seal measurements were performed according to ASTM F-88, which is designed to measure the force required to separate a seal after the material has completely cooled to 23° C. The samples were sealed using a Kopp instrument, and conditioned for 24 hours at 23° C., before testing in an Instron Tensile Tester. The following parameters were used.

### Specimen Width: 25.4 mm (1.0 in)

Sealing Pressure: 0.27 N/mm2 (40 psi)

### Sealing Dwell Time: 0.5 s

Direction of Pull: 90° to seal
Peel speed: 254 mm/min (10 in/min)
Number of samples per temperature: 5

### Heat Seal and Hot Tack Optimum Range

Heat Seal Initiation Temperature (HSIT) is defined as the temperature at which a seal strength of 1 lb/inch is obtained. This definition is only a benchmark, since the required heat seal strength will vary from application to application. Ultimate seal strength is the highest heat seal strength obtained on a curve of seal strength versus seal temperature.

For the film used to form a flexible packaging container for a liquid such as water, the following characteristics are preferred:

a heat seal initiation temperature of 100° C. or less, preferably 90° C. or less,

an ultimate seal strength of at least 4 lbf/in.

In the case of hot tack, temperature at which the hot-tack strength is 4 N/inch is taken as the hot-tack initiation temperature. This value is a benchmark only, since the minimum requirement for hot tack will vary from application to application. Ultimate hot-tack strength is the peak value (maximum hot tack strength) of the curve. Hot tack range is the temperature range across which a minimum hot tack value is obtained.

For a film to be used to form a flexible packaging container for a liquid, such as water, the following characteristics are preferred:

a hot tack initiation temperature of 100° C. or less,

an ultimate hot tack strength of at least 6 N/in,

a hot tack range or at least 25° C., at which at least hot tack strengths of 4 N/in.

By using an propylene-based interpolymer, as described herein, in a sealant layer in a film used to form a flexible packaging container for a liquid such as water, the above mentioned characteristics are obtained.

### EXPERIMENTAL

### Materials

A18 (AFFINITY™ 1880G, available from The Dow Chemical Company) is an ethylene-octene copolymer having a density of 0.902 g/cc and an I₂ of 1.0 g/10 min (190° C./2.16 kg).

E54 (ELITET™ 5400G, available from The Dow Chemical Company) is an polyethylene resin having a density of 0.916 g/cc and an I₂ of 1.0 g/10 min (190° C./2.16 kg).

D045 (DOWLEX™ 2045G, available from The Dow Chemical Company) is a linear low density ethylene-octene copolymer having a density of 0.920 g/cc and a MFI of 1 g/10 min (190° C., 2.16 kg).

PE32 (DOW LDPE132I, available from The Dow Chemical Company), is a low density polyethylene having a density of 0.921 g/cc and a MFI of 0.25 g/10 min (190° C., 2.16 kg).

PE64 (DOW LDPE 640I, available from The Dow Chemical Company) is a low density polyethylene having a density of 0.922 g/cc and an I₂ of 2.0 g/10 min (190° C./2.16 kg).

V22 (VERSIFY™ 2200, available from The Dow Chemical Company) is a propylene-ethylene copolymer having a density of 0.876 g/cc and an MFR of 2 g/10 min (230° C./2.16 kg).

HDPE64 (UNIVAL™ DMDH-6400 NT 7, available from The Dow Chemical Company) is a high density polyethylene having a density of 0.961 g/cc and an I₂ of 0.8 g/10 min (190° C./2.16 kg).

hPP31 is a polypropylene homopolymer with an MFR of 2 g/10 min (230° C./2.16 kg).

rPP6D is a random propylene/ethylene copolymer with an MFR of 1.9 g/10 min (230° C./2.16 kg).

Antioxidants include IRGAFOS 168, IRGANOX 1010 and IRGANOX 1076. IRGAFOS 168 (available from Ciba) is a phosphite antioxidant. IRGANOX 1010 (available from Ciba) is a hindered phenolic antioxidant. IRGANOX 1076 (available from Ciba) is a monofunctional hindered phenolic antioxidant.

Zeolite (ABSCENTS 3000, available from UOP LLC) is an aluminum silicate with an average particle size of less than 10 μm.

Slip (Ampacet 102780, available from Ampacet) is an erucamide masterbatch with 5% erucamide as active ingredient and VERSIFY™ 3200 as carrier resin.

Antiblok or AB (Ampacet 102777, available from Ampacet) is an antiblock masterbatch with 20% diatomaceous earth as active ingredient and VERSIFY™ 3200 as carrier resin.

Slip (Ampacet 102780, available from Ampacet) is an erucamide masterbatch with 5% erucamide as active ingredient and VERSIFY™ 3200 as carrier resin. This slip masterbatch was added to all VERSIFY™ resins when slip is indicated.

Antiblok or AB (Ampacet 102777, available from Ampacet) is an antiblock masterbatch with 20% diatomaceous earth as active ingredient and VERSIFY™ 3200 as carrier resin. This antiblock masterbatch was added to all VERSIFY™ resins when antiblock is indicated,

Slip (Ampacet 100329, available from Ampacet) is an erucamide masterbatch with 5% erucamide as active ingredient and AFFINITY™ as carrier resin. This slip masterbatch was added to DOWLEX™ and LDPE resins when slip is indicated,

Antiblok or AB (Ampacet 100342, available from Ampacet) is an antiblock masterbatch with 20% white mist as active ingredient and AFFINITY™ as carrier resin. This antiblock masterbatch was added to DOWLEX™ and LDPE resins when antiblock is indicated.

Processing aid or PA (Dynamar FX 5922X, available from Dyneon) is a processing aid masterbatch with 6% fluoropolymer as active ingredient and VERSIFY™ 3200 as carrier resin.

V32 (VERSIFY™ 3200, available from The Dow Chemical Company) is a propylene-ethylene copolymer having a density of 0.876 g/cc and an MFR of 8 g/10 min (230° C./2.16 kg).

INCROSLIP B (available from Croda) is a slip masterbatch with 5% benhenamide as active ingredient.

INCROSLIP C (available from Croda) is a slip masterbatch with 5% erucamide as active ingredient.

Ampacet 101724-U is a slip polyethylene masterbatch with 10% ultra high molecular weight siloxane polymer as active ingredient. The carrier resin is LDPE.

V20 (VERSIFY™ 2000, available from The Dow Chemical Company) is a propylene-ethylene copolymer having a density of 0.888 g/cc and an MFR of 2 g/10 min (230° C./2.16 kg).

V23 (VERSIFY™ 2300, available from The Dow Chemical Company) is a propylene-ethylene copolymer having a density of 0.866 g/cc and an MFR of 2 g/10 min (230° C./2.16 kg).

V30 (VERSIFY™ 3000, available from The Dow Chemical Company) is a propylene-ethylene copolymer having a density of 0.888 g/cc and an MFR of 8 g/10 min (230° C./2.16 kg).

A list of the compositions evaluated for taste properties is shown in Tables 4-5 below.

The “ppm” amounts of additives, listed in Tables 4 and 5, are each based on the total weight of each composition.

### Composition Preparation

Compositions for the monolayer films were prepared in a twin screw extruder (Haake Rheomex PTW 25) at a melt temperature of 205° C. The melt string was cooled down with a chilled water bath and pelletized. To add slip, antiblock, processing aid, and zeolites, the resins were compounded with the appropriate masterbatch(es) in the twin screw extruder. Compositions for the multilayer coextruded films were dry blended.

### Blown Film Preparation

For the monolayer films, the compounded pellets or virgin pellets (if no additives were added) were processed at a monolayer blown film pilot line (Davis-Standard/Killion) with a 1¼ in extruder, 30:1 L/D and 3 in spiral fed die. The “blow up” ratio was 2.5, and the melt temperature varied from 428° F. (220° C.) and 458° F. (237° C.). For the same material, the temperature was kept constant. The nominal film thickness was either 4 or 2 mils. The films were wrapped in aluminum foil and sent for panel testing.

For the multilayer coextruded films, the dry blends were processed at a three-layer coextrusion blown film line (Battenfeld Gloucester) with two 2½ in 24:1 L/D extruders and one 2 in 24:1 L/D extruder. The line is equipped with a 6 in die and air ring (Macro). The “blow up” ratio was 2.5, and the melt temperature varied from 428° F. (220° C.) and 458° F. (237° C.). The nominal film thickness was 2 mils. The films were wrapped in aluminum foil and sent for testing.

### Evaluation of Taste Performance

Ozone sterilized water samples (also referred to as ozonated samples) and non-ozonated water samples were prepared for comparison. For the non-ozonated water samples, blown film (5 g) was immersed in 900 mL of Ozarka brand drinking water, and kept for 20 hours, at room temperature, in a closed glass jar. For ozonated water samples, blown film (5 g) was immersed in 900 mL of Ozarka brand drinking water, and ozone generated by an OzoneLab™ 0L80F/S ozonation equipment (Ozone Services) was bubbled into the water for a specific time, until the OzoneLab™ ORP Monitor Probe (Ozone Services) measured 810 mV, which corresponds to 0.4 ppm ozone, according to the instrument calibration curve. The glass jar was closed, and also kept for 20 hours at room temperature.

The water samples were then given to a group of 24 trained panelists for taste evaluation. A maximum of four samples were randomly presented to the panelists, along with a replicate set to check for reproducibility. Each set of at the most four samples was ranked according to taste intensity from 1 to n; 1 being the least intense, and n being the most intense (n=maximum number of samples tested). In addition, each sample was subject to a hedonic rating from 1 to 9; 1 being “dislike extremely” and 9 being “like extremely.” Traditionally, Ozarka brand drinking water has been rated by the panelists as 5.2, which corresponds to “neither like nor dislike.” Panelists also provided a taste descriptor for each sample (for example, “no taste,” “polymer,” “bitter,” etc.). For comparison, the results of the panelist evaluations were represented as plots of intensity ranking versus hedonic rating.

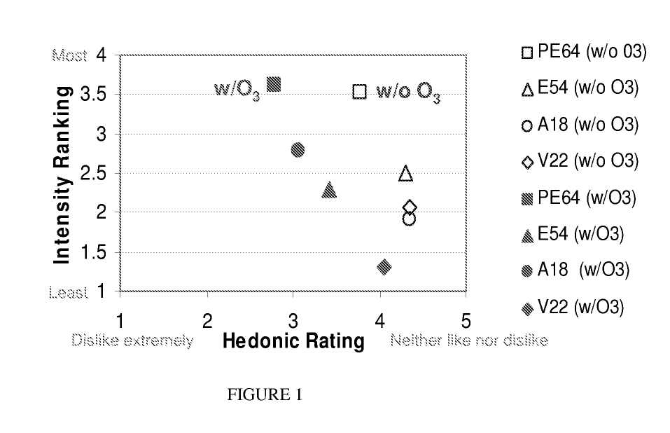

The taste performance of water samples exposed to a film formed from V22 with the standard antioxidant package were evaluated and compared to water samples exposed to films formed from typical polyethylene sealants, such as high density polyethylene (HDPE), and polypropylene (PP). Additive versions of V22 were also evaluated. Tables 4-5 describes in detail the samples evaluated by the panel. The taste results and other film properties are shown in FIGS. 1-6.

TABLE 4

| | | | | |
|---|---|---|---|---|
| | | | MFR or I2 | Density |
| Ex | Polymer | Additives | (g/10 min) | (g/cc) |

| | | | | |
|---|---|---|---|---|
| 1 | A18 | Antioxidants | 1 | 0.902 |
| 2 | E54 | Antioxidants | 1 | 0.916 |
| 3 | PE64 | none | 2 | 0.922 |
| 4 | V22 | Antioxidants | 2 | 0.876 |
| 5 | HDPE64 | Antioxidants | 0.8 | 0.961 |
| 6 | hPP31 | Antioxidants | 2 | 0.900 |
| 7 | rPP6D | Antioxidants | 1.9 | — |
| 8 | V22 w/1000 ppm zeolites | Antioxidants; ABSCENTS 3000 (1000 ppm) | — | — |
| 9 | V22 w/2000 ppm zeolites | Antioxidants; ABSCENTS 3000 (2000 ppm) | — | — |
| 10 | V22 w/3000 ppm zeolites | Antioxidants; ABSCENTS 3000 (3000 ppm) | — | — |
| 11 | V22 w/slip | Antioxidants; erucamide (2500 ppm) | — | — |
| 12 | V22 w/antiblock | Antioxidants; diatomaceous earth (3000 ppm) | — | — |
| 13 | V22 w/processing aid | Antioxidants; fluoropolymer based PA (600 ppm) | — | — |

TABLE 5

| | | | MFR or I2 | Density |
|---|---|---|---|---|
| Ex. | Polymer | Additives | (g/10 min) | (g/cc) |
| 14 | V22 w/slip, AB and | Antioxidants; erucamide (2500 ppm); | — | — |
| | and PA | diatomaceous earth (3000 ppm); | | |
| | | fluoropolymer based PA (600 ppm) | | |
| 15 | V22 w/slip, AB, PA | Antioxidants; erucamide (2500 ppm); | — | — |
| | and zeolites | diatomaceous earth (3000 ppm); | | |
| | | fluoropolymer based PA (600 ppm); | | |
| | | ABSCENTS 3000 (1000 ppm) | | |
| 16 | V22 w/slip, AB, PA | Antioxidants; erucamide (2500 ppm); | — | — |
| | and zeolites | diatomaceous earth (3000 ppm); | | |
| | | fluoropolymer based PA (600 ppm); | | |
| | | ABSCENTS 3000 (2000 ppm) | | |
| 17 | V22 w/slip, AB, PA | Antioxidants; erucamide (2500 ppm); | — | — |
| | and zeolites | diatomaceous earth (3000 ppm); | | |
| | | fluoropolymer based PA (600 ppm); | | |
| | | ABSCENTS 3000 (3000 ppm) | | |
| 18 | V22 w/INCROSLIP B, | Antioxidants; benhenamide (2500 ppm); | — | — |
| | AB, PA | diatomaceous earth (3000 ppm); | | |
| | | fluoropolymer based PA (600 ppm) | | |
| 19 | V22 w/INCROSLIP | Antioxidants; erucamide (2500 ppm); | — | — |
| | C, AB, PA | diatomaceous earth (3000 ppm); | | |
| | | fluoropolymer based PA (600 ppm) | | |
| 20 | V22 w/AMPACET | Antioxidants; siloxane (10000 ppm); | — | — |
| | 101724-U, | diatomaceous earth (3000 ppm); | | |
| | AB, PA (C1) | fluoropolymer based PA (600 ppm) | | |
| 21 | V22 w/AMPACET | Antioxidants; siloxane (15000 ppm); | — | — |
| | 101724-U, | diatomaceous earth (6000 ppm); | | |
| | AB, PA (C2) | fluoropolymer based PA (600 ppm) | | |
| 22 | DO45/PE32 | Antioxidants; erucamide (1500 ppm); | | |
| | w/slip, AB | White mist (3000 ppm) | | |

FIG. 1 compares the taste of the non-ozonated and ozonated water samples exposed to V22, with the antioxidants, with the taste of water samples exposed to films formed from typical polyethylene sealants. These films contain the same type and level of antioxidants, except for PE64, which contains no additives. For non-ozonated water, PE64 contributes the most intense taste to water, whereas A18, E54, and V22 contribute the least intense taste, being rated at about 4.3, as “disliked slightly,” which indicates that they are acceptable for use in food and specialty packaging applications. In particular, polyethylene sealants, such as A18, are known to have little or no contribution to taste and odor.

With ozonation, the taste performance of the polyethylene sealants changed significantly from “disliked slightly” to “dislike moderately,” whereas V22 retained its hedonic rating, and contributed the least intense taste to water, as compared to PE64, which remained the worst performer.

Off-taste of polymeric materials is typically caused by a perceivable amount, usually in ppb, of short-chain (C4-C11) aldehydes and ketones in the taste medium.

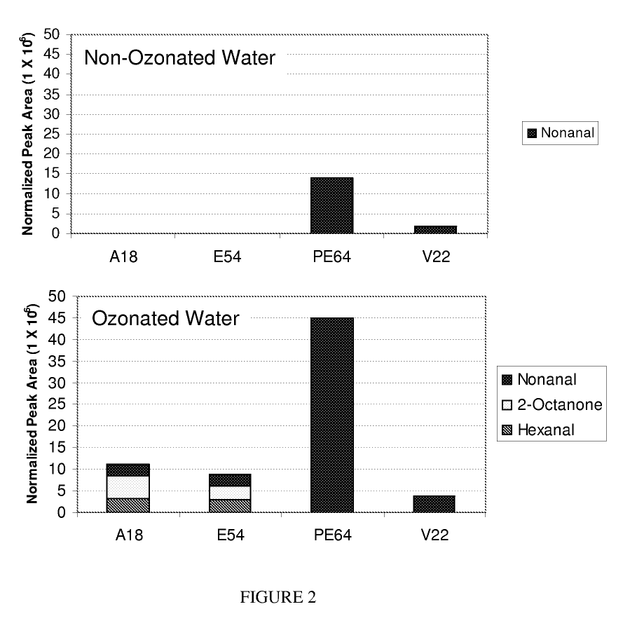

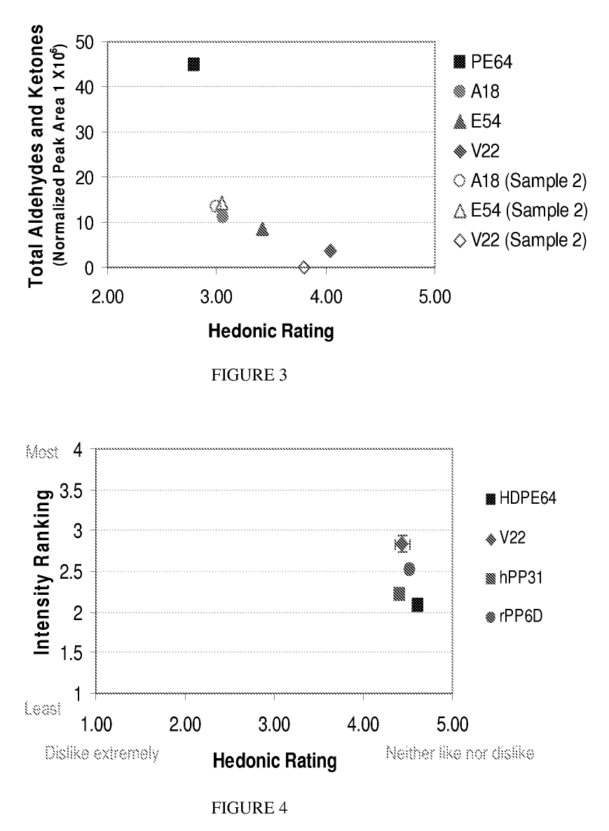

FIG. 2 shows the relative amount of aldehydes and ketones found in the non-ozonated and ozonated water samples discussed in FIG. 1. The amount of these species was determined by Immersion SPME (Solid-Phase Microextraction). In the case of non-ozonated water, PE64, which contributed the most intense taste to water, exhibited the highest nonanal content, whereas aldehydes and ketones were not detected in the other polyethylene sealants, which had acceptable taste. With ozonation, the nonanal content in PE64 increased three-fold, and a fair amount of C6-C9 aldehydes and ketones were found in the polyethylene sealants, rated as “dislike moderately.” The small amount of nonanal detected in the V22 sample, which had the best taste performance, did not change significantly with ozonation. The good correlation between the relative amount of aldehydes and ketones, detected in the water, and the ozonated water taste performance of the sealants is summarized in FIG. 3.

The ozonated water taste performance of V22 was compared to existing technologies, such as rigid containers and the addition of zeolites. The V22 sample performed very similarly to a HDPE64 sample, which can be used to form rigid containers, such as water jugs, in an ozonated water packaging process (see FIG. 4). FIG. 4 also shows that polypropylene homopolymer (hPP) and random polypropylene copolymer (rPP) exhibit comparable taste performance to V22. No aldehydes or ketones were found in any of these samples after ozonation. Compared to HDPE, hPP, and rPP, the V22 offers a unique combination of seal performance and taste for ozonated water packaging.

A five weight percent zeolite masterbatch was prepared with V32, as the carrier resin, and ABSCENTS™ 3000, as the active ingredient. This masterbatch was added to V22 to achieve final concentrations of 1000 ppm, 2000 ppm and 3000 ppm ABSCENTS™ 3000 (based on total weight of the composition). FIG. 5 shows that the addition of the zeolite did not improve the ozonated water taste performance of V22.

For automatic packaging, a low Coefficient of Friction (COF) is required. Slip and antiblock agents are usually added to reduce COF. If a slip agent, such as erucamide, is added to V22, the ozonated water taste performance of water, exposed to a film prepared from this V22 composition, worsens significantly from “dislike slightly” to “dislike very much,” or from 4 to 2. On the other hand, the addition of antiblock and other additives, such as a processing aid, does not seem to significantly affect the taste performance of V22. In order to adequately control COF, without affecting the ozonated water taste performance of V22, other types of slip agents and zeolites were evaluated. FIG. 5 shows that, as in the case of V22 without slip agent, the addition of zeolites did not improve the taste of V22 with slip agent, which is a similar result to the case where zeolites were added to V22 without a slip agent. On the other hand, FIG. 6 shows the hedonic rating of V22 with several slip agents against kinetic COF. The slip agents that do not seem to affect the taste performance of VERSIFY are those without any unsaturations, for example, INCROSLIP B (Croda, benhenamide slip agent) and AMPACET 101724-U (siloxane as active ingredient in a LLDPE masterbatch) as previously reported. The non-migratory slip, siloxane concentrate, provides the best combination of COF and ozonated water taste performance to V22.

### GC-Mass Spec Study

### Description

The film samples for GC/MS analysis were exposed to ozonated water, prepared in the same way as for taste evaluation studies. Blown film (5 g) was immersed in 900 mL of Ozarka brand drinking water, and ozone generated by an OzoneLab™ 0L80F/S ozonation equipment (Ozone Services) was bubbled into the water for a specific time, until the OzoneLab™ ORP Monitor Probe (Ozone Services) measured 810 mV, which corresponded to 0.4 ppm ozone, according to the instrument calibration curve. The glass jar was closed, and also kept for 20 hours at room temperature.

The films were then analyzed by GC/MS using a Ruska ThermEx system interfaced to a Finnigan SSQ-710 GC/MS system. The Finnigan GC/MS system was equipped with a 30 m×0.25 mm×1 μm DB-5 MS fused silica capillary column. About 0.14 g of sample was transferred to a clean crucible of the ThermEx system. The sample was heated to 200° C., while helium carrier gas transported the volatile and semi-volatile materials to a liquid nitrogen cooled GC column trap. After heating and purging, the cryogenic trap was heated electrically to vaporize the trapped materials in the GC column. Electron ionization mass spectra were acquired on the eluted components at one-second intervals for component identification. The mass spectra were further analyzed using specialized software to integrate the area under the curve.

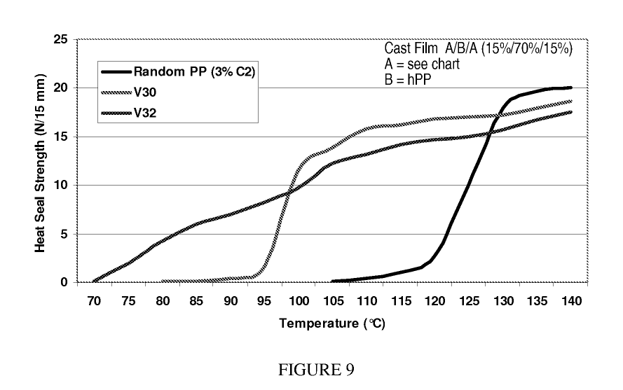

Table 6 relates hedonic rating with the integrated area under the curve of the thermal desorption GC/MS analysis for each sample. As an example, FIG. 9 shows the thermal desorption GC/MS analysis for PE64. The area under the curve of the “relative abundance” versus time plot, is an indication of the amount of low molecular weight material present in the sample. Table 6 shows, unexpectedly, that the films prepared from the propylene-based polymers of the invention (V20, V22, V23) have an excellent hedonic rating (based on ozonated water), despite some relatively higher area measurements (see V20 and V23).

TABLE 6
GC/MS Spec and Hedonic Rating

| | | Hedonic | Integrated |
|---|---|---|---|
| No. | Polymer | Rating | Area |
| 1 | A18 | 2.9 ± 0.2 | 3652 |
| 2 | PE64 | 2.80 | 8105 |
| 3 | V22 | 4.3 ± 0.3 | 3965 |
| 4 | HDPE64 | 4.60 | 7196 |
| 5 | hPP31 | 4.40 | 7818 |
| 6 | V20 | 3.60 | 7664 |
| 7 | V23 | 4.40 | 5218 |

### Heat Seal and Hot Tack Strength Study

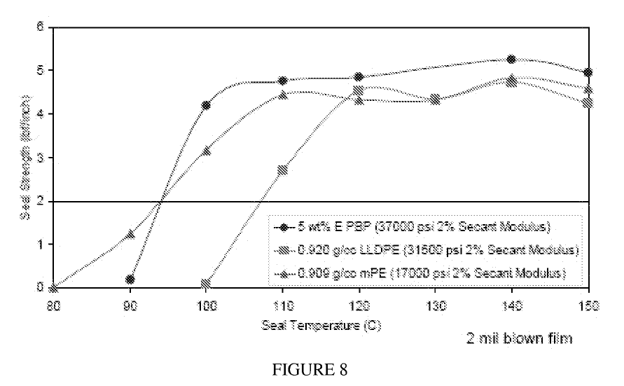

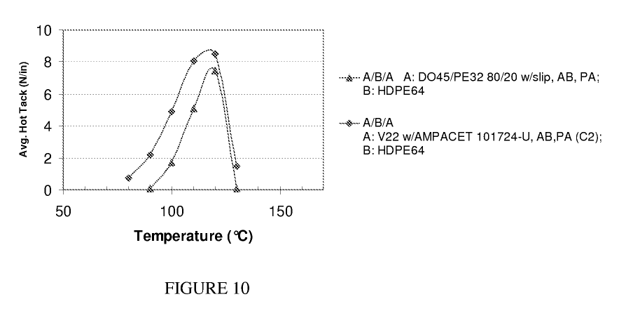

The heat seal strength (ASTM F-88 test method) of several films was measured, and results are shown in FIGS. 8 and 9. As can be seen in FIG. 10, the film formed from a propylene-based polymer of an inventive composition (5 wt % E PBP film) showed comparable seal strength at higher seal temperatures (>100 C) compared to films prepared from a LLDPE and a mPE, respectively. The propylene-based polymer of an inventive composition also showed better seal strength at lower seal temperatures (<100 C) compared to the film prepared from the LLDPE.

In regard to FIG. 9, left to right, the first profile is V32, the second profile is V30, and the third profile is the random PP. As can be seen in FIG. 11, the films containing an outer layer formed from a propylene-based polymer (V30 or V32) of an inventive composition, each showed better heat seal strengths at lower seal temperatures (<100° C.), as compared to a film containing an outer layer prepared from another random propylene-based interpolymer.

The hot tack strength (ASTM F-1921 test method) of several coextruded films with different outer layers and a core made of HDPE64 was measured, and results are shown in FIG. 10. As can be seen in FIG. 10, the film containing an outer layer made from the inventive composition, showed better hot tack strengths at lower seal temperatures (<110° C.) and a slightly higher ultimate hot tack strength, as compared to a film containing an outer layer prepared from a blend of LLDPE and LDPE.

Although the invention has been described in certain detail through the preceding specific embodiments, this detail is for the primary purpose of illustration. Many variations and modifications can be made by one skilled in the art, without departing from the spirit and scope of the invention, as described in the following claims.

1-50. (canceled)

51. A composition comprising a propylene-based interpolymer and a saturated compound selected from the group consisting of aliphatic amides, hydrocarbon waxes, hydrocarbon oils, fluorinated hydrocarbons and siloxanes, and
wherein the propylene-based interpolymer comprises (a) greater than 50 mole percent propylene, based on the total moles of polymerizable monomers, and (b) ethylene, or ethylene and one or more unsaturated comonomers, or one or more unsaturated comonomers, and
wherein the propylene-based interpolymer has at least one of the following properties:
(i) 13C NMR peaks corresponding to a regio-error at about 14.6 and about 15.7 ppm, the peaks of about equal intensity, and
(ii) a DSC curve with a Tₘₑ that remains essentially the same, and a Tₘₐₓ that decreases as the amount of comonomer in the interpolymer is increased.

52. The composition of claim 51, wherein the saturated compound contains a structural unit represented by Formula (I): 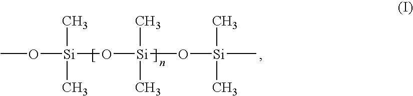
where n is greater than 10.

53. The composition of any of claim 51, wherein the saturated compound is represented by Formula (II):
CH₃—(CH₂)ₙ—CONH₂ (II),
wherein n is greater than, or equal to, 6.

54. The composition of any of claim 51, wherein the saturated compound is a hydrocarbon wax.

55. The composition of any of claim 51, wherein the saturated compound is a hydrocarbon oil.

56. The composition of any of claim 51, wherein the saturated compound is a fluorinated hydrocarbon.

57. The composition of claim 51, wherein the propylene-based interpolymer is a propylene/ethylene interpolymer.

58. A film comprising at least one layer formed from the composition of claim 51.

59. A film comprising at least three layers, and wherein at least one outer layer is formed from the composition of any of claim 51.

60. The film of claim 59, comprising an inner layer formed from a composition comprising a HDPE, polypropylene homopolymer, or a propylene-based interpolymer.

61. The film of any of claim 51, wherein the film has a seal strength of at least 1 lbf/inch at a sealing temperature in the range from 100° C. or less.

62. A laminate structure comprising a film formed from the composition of any of claim 51, and a substrate, and wherein the film is laminated to the substrate.

63. The laminate structure of claim 62, wherein the substrate is formed from a composition comprising at least one selected from foil, polyamide, polyester, ethylene/vinyl alcohol (EVOH) copolymers, polyvinylidene chloride (PVDC), polyethylene terepthalate (PET), oriented polypropylene (OPP), ethylene/vinyl acetate (EVA) copolymers, ethylene/acrylic acid (EM) copolymers, ethylene/methacrylic acid (EMAA) copolymers, SiOx coated films, PVDC coated films, ULDPE, LLDPE, HDPE, MDPE, LMDPE, LDPE, ionomers, graft-modified polymers, or paper.

64. The laminate structure of claim 63, wherein the substrate is formed from a composition comprising at least one selected from foil, nylon, ethylene/vinyl alcohol (EVOH) copolymers, polyvinylidene chloride (PVDC), polyethylene terepthalate (PET), oriented polypropylene (OPP), SiOx coated films, or PVDC coated films.

65. A film pouch comprising at least one component formed from the composition of any of claim 51.

66. The film pouch of claim 65, wherein an interior layer of the pouch is formed from the composition of any of claim 51.

67. The film pouch of any of claim 66, wherein an outer layer of the pouch is formed from a composition comprising a HDPE, a polypropylene homopolymer, or a propylene-based interpolymer.

68. A pouch comprising a film layer formed from a composition comprising a propylene-based interpolymer, and
wherein the propylene-based interpolymer comprises (a) greater than 50 mole percent propylene, based on the total moles of polymerizable monomers, and (b) ethylene, or ethylene and one or more unsaturated comonomers, or one or more unsaturated comonomers, and
wherein the propylene-based interpolymer has at least one of the following properties:
(i) 13C NMR peaks corresponding to a regio-error at about 14.6 and about 15.7 ppm, the peaks of about equal intensity, and
(ii) a DSC curve with a Tₘₑ that remains essentially the same, and a Tₘₐₓ that decreases as the amount of comonomer in the interpolymer is increased.

69. The pouch of claim 68, wherein the propylene-based interpolymer has a density from 0.86 to 0.90 g/cc.

70. The pouch of claim 68, wherein the composition comprises a saturated compound selected from the group consisting of aliphatic amides, hydrocarbon waxes, hydrocarbon oils, fluorinated hydrocarbons and siloxanes.
